(19) United States
(12) Patent Application Publication
(10) Pub. No.: US 2024/0344920 A1
(43) Pub. Date: Oct. 17, 2024

(54) APPARATUSES, SYSTEMS AND METHODS FOR VIAL SEAL INSPECTION

(71) Applicant: AMGEN INC., Thousand Oaks, CA (US)

(72) Inventors: Al Patrick Goodwin, Dunleer (IE); Joseph Peter Bermacki, Thousand Oaks, CA (US); Thomas Clark Pearson, Newbury Park, CA (US); Graham F. Milne, Ventura, CA (US); Jonathan Parsons, Thousand Oaks, CA (US); Corey Bishop, Thousand Oaks, CA (US); Barry Donohoe, Thousand Oaks, CA (US); Osvaldo Perez-Varela, Guaynabo, PR (US)

(21) Appl. No.: 18/685,086

(22) PCT Filed: Aug. 22, 2022
(86) PCT No.: PCT/US22/40983

§ 371 Date: Feb. 20, 2024

Related U.S. Application Data
(60) Provisional application No. 63/235,834, filed on Aug. 23, 2021.

(51) Int. Cl. G01M 3/38; G01B 11/25; G01N 21/90

(52) U.S. Cl. CPC G01M 3/38; G01B 11/2522; G01N 21/909; G01N 2201/0612

(57) ABSTRACT

An apparatus, system, or method for vial seal inspection may be based on three-dimensional data that is representative of at least a portion of a vial seal. More particularly, apparatuses, systems, and methods for vial seal inspection may include at least one laser triangulation sensor.

### CROSS-REFERENCE TO RELATED APPLICATION

Priority is claimed to U.S. Provisional Patent Application No. 63/235,834, filed Aug. 23, 2021, the entire contents of which are hereby incorporated by reference herein.

### FIELD OF DISCLOSURE

The present disclosure generally relates to apparatuses, systems, and methods for vial seal inspection using three-dimensional data that is representative of at least a portion of a vial seal. More particularly, the present disclosure relates to apparatuses, systems, and methods for vial seal inspection using a laser triangulation sensor.

### BACKGROUND

Under FDA requirements, many products (e.g., filled and sealed vials of medicine, etc.) need to be 100% inspected. Vial seal crimp inspection is one example. Vial seal crimp inspection is currently implemented using two-dimensional (2D) vision-based inspection. Among other sources of error, known 2D vial seal crimp inspection is prone to errors due to associated illumination conditions.

Variations in crimp material (e.g., an anodized form of aluminum, etc.) may result in different levels of reflections. Therefore, when an associated 2D vision system is configured to, for example, detect defects on one batch of aluminum vial seals, the system may achieve success on the batch of sealed vials. However, future batches of sealed vials may not result in the same image(s) due to variations in seal surface finishing, slight variations in vial seal surface color, etc. Known 2D vial seal crimp inspection often includes illuminating an associated vial seal crimp area of the respective vials during inspection. All these issues may cause false fails (i.e., a false fail is a sealed vial having a good vial seal crimp erroneously identified as being a bad vial seal). In any event, known inspection system errors often result in false fails.

A vial seal crimping process often includes a mechanical process which may be performed after successful filling of an associated vial. As described in detail herein, the mechanical nature of vial seal crimping processes and/or variations in associated vials (e.g., a glass container, etc.) often results in vial seal crimp defects.

As part of a filled and sealed vial inspection, known 2D vial seal crimp inspection may be incorporated into an automatic visual inspection (AVI) system. In known vial seal inspection systems, a sealed vial may be rotated 360 degrees about a central axis of the vial, multiple two-dimensional (2D) images may be taken at various points about the vial rotation, and these 2D images may be analyzed using, for example, machine vision-based algorithms to detect seal defects. False fails often occur due to variations of associated 2D vision-based systems.

Apparatuses, systems, and methods are needed for vial seal inspection to reduce false fails compared to traditional two-dimensional vision-based vial seal inspection. Apparatuses, systems, and methods are needed for vial seal inspection using three-dimensional data that is representative of at least a portion of a vial seal surface. Apparatuses, systems, and methods are also needed for vial seal inspection using at least one laser triangulation device.

### SUMMARY

A vial seal inspection system may include a vial seal distance data generation device configured to generate vial seal distance data. The vial seal distance data may be representative of a plurality of distance measurements correlated with points along at least a portion of a line that extends from a top of the vial seal to a bottom edge of the vial seal. The system may also include a vial seal periphery data generation device configured to generate vial seal periphery data. The vial seal periphery data may be representative of a plurality of points along at least a portion of a line that extends around a periphery of the vial seal. The system may further include a vial seal three-dimensional data generation module stored on a memory that, when executed by a processor, may cause the processor to generate vial seal three-dimensional data based on the vial seal distance data and the vial seal periphery data. The system may yet further include a vial seal inspection data generation module stored on a memory that, when executed by a processor, may cause the processor to generate vial seal inspection data based on a comparison of the vial seal three-dimensional data with previously classified vial seal three-dimensional data. The vial seal inspection data may be indicative of whether the vial seal includes a vial seal crimp.

In another embodiment, a vial seal inspection device may include a vial seal distance data generation sensor configured to generate vial seal distance data. The vial seal distance data may be representative of a plurality of distance measurements correlated with points along a line that extends from a top of the vial seal to a bottom edge of the vial seal. The device may also include a vial seal periphery data input. The vial seal periphery data input may be representative of a plurality of points along at least a portion of a line that extends around a periphery of the vial seal. The device may further include a vial seal three-dimensional model generation module stored on a memory that, when executed by a processor, may cause the processor to generate vial seal three-dimensional data based on the vial seal distance data and the vial seal periphery data.

In a further embodiment, a non-transitory computer-readable medium storing computer-readable instructions that, when executed by one or more processors, cause the one or more processors to generate vial seal three-dimensional data may include a vial seal distance data receiving module that, when executed by a processor, may cause the processor to receive vial seal distance data from a vial seal distance data generation device. The vial seal distance data may be representative of a plurality of distance measurements correlated with points along at least a portion of a line that extends from a top of the vial seal to a bottom edge of the vial seal. The computer-readable medium may also include a vial seal periphery data receiving module that, when executed by a processor, may cause the processor to receive vial seal periphery data. The vial seal periphery data may be representative of a plurality of points along at least a portion of a line that extends around a periphery of the vial seal. The computer-readable medium may further include a vial seal three-dimensional data generation module that, when executed by a processor, may cause the processor to generate vial seal three-dimensional data based on the vial seal distance data and the vial seal periphery data.

### BRIEF DESCRIPTION OF THE DRAWINGS

It is believed that the disclosure will be more fully understood from the following description taken in conjunction with the accompanying drawings. Some of the drawings may have been simplified by the omission of selected elements for the purpose of more clearly showing other elements. Such omissions of elements in some drawings are not necessarily indicated of the presence or absence of particular elements in any of the exemplary embodiments, except as may be explicitly delineated in the corresponding written description. Also, none of the drawings are necessarily to scale.

FIG. 1 depicts an example sealed vial having a flip cap;

FIGS. 2A-C depict example components for sealing a vial;

FIG. 3 depicts an example system for crimping a vial seal using high speed rotating blades;

FIG. 4A depicts an example vial seal having a damaged periphery portion and crimp portion;

FIG. 4B depicts an example vial seal having a dented periphery portion;

FIG. 4C depicts an example vial seal having a crimp portion partially torn off from a respective periphery portion;

FIG. 4D depicts an example vial seal having a loose crimp portion;

FIG. 4E depicts an example vial seal having a misaligned crimp portion;

FIG. 4F depicts an example vial seal having no crimp portion;

FIG. 4G depicts an example vial seal having a rippled crimp portion;

FIG. 4H depicts an example vial with no seal;

FIGS. 5A-C depict an example vial seal having a partial crimp portion;

FIGS. 6A-F depict various example vial seals;

FIG. 7 depicts example vial seal inspection batch data showing vial seal fails using a two-dimension (2D) vial seal crimp inspection;

FIGS. 8A and 8B depict an example vial seal inspection system;

FIGS. 9A-C depict an example automatic visual inspection (AVI) apparatus having two laser triangulation sensors;

FIGS. 10A and 10B depict example laser triangulation sensors;

FIG. 11A depicts a high-level block diagram of an example vial seal inspection system;

FIG. 11B depicts a block diagram of an example vial seal inspection sensor;

FIG. 11C depicts an example method for implementing a vial seal inspection sensor;

FIG. 11D depicts a block diagram of an example vial seal inspection device;

FIG. 11E depicts an example method for implementing a vial seal inspection device;

FIG. 11F depicts a block diagram of an example remote device;

FIG. 11G depicts an example method for implementing a remote device;

FIG. 12 depicts an example three-dimensional representation of an “unwrapped” vial seal crimp portion;

FIGS. 13A and 13B depict an example three-dimensional model of a damaged seal and seal crimp;

FIGS. 14A and 14B depict an example three-dimensional model of a bruised seal;

FIG. 15 depicts an example vial seal having a weak crimp portion;

FIG. 16 depicts an example vial seal missing a crimp portion;

FIG. 17 depicts a three-dimensional model of a full 360 degree profile of a vial seal crimp having 0.1 mm resolution;

FIG. 18 depicts an example image generated using distance data associated with a vial seal inspection for a vial seal having a blue colored periphery surface;

FIG. 19 depicts eight example images generated using distance data associated with a vial seal inspection for a vial seal having a blue colored periphery surface;

FIGS. 20A-D depict vial seal three-dimensional models using vial seal distance data generated from a laser triangulation sensor with various exposure levels; and

FIGS. 21A-D depict a series of vial profile views having varying amounts of seal material tucked under a lip of a vial neck.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercial feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Apparatuses, systems, and methods of the present disclosure may, for example, inspect a vial seal based on three-dimensional (3D) data that is representative of at least a portion of a vial seal. Vial seal inspection may occur in real time with respect to, for example, an associated vial seal crimping process.

The apparatuses, systems, and methods of the present disclosure may, for example, include at least one laser triangulation sensor in conjunction with vial seal periphery data, to provide X-axis data, Y-axis data, and Z-axis data that is representative of at least a portion of a vial seal. Sealed vials may be rejected with lower false fails using vial seal 3D data compared to vial seal crimp inspection systems based on two-dimensional data. The vial seal periphery data may be, for example, pre-determined (e.g., vial seal periphery data may be based on a perimeter length of at least a portion of a vial seal, vial seal periphery data may be based on a vial rotation time, etc.). Alternatively, or additionally, the vial seal periphery data may be generated via, for example, a feedback sensor output. Feedback sensor output data (i.e., X-axis data) may be directly correlated with respective Y-axis data, and Z-axis data. More broadly, Y-axis data and Z-axis data from a vial seal distance data generation sensor may be correlated with X-axis data representative of points along at least a portion of a perimeter of a vial seal.

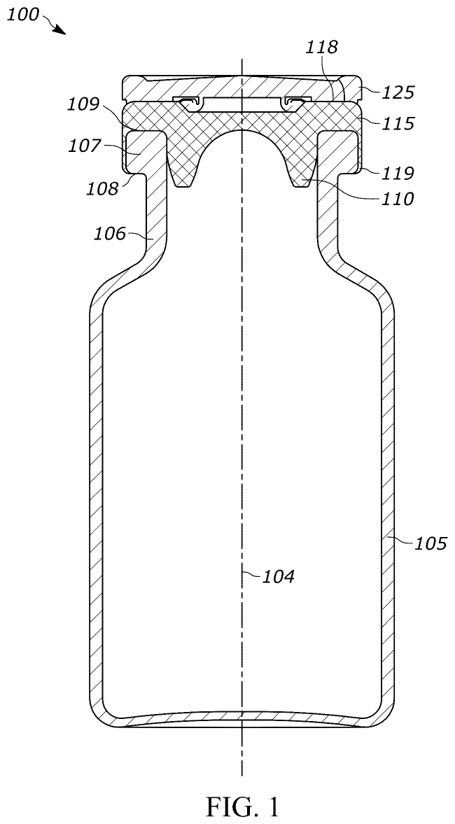

Turning to FIG. 1, a sealed vial 100a may include a vial 105 (e.g., a glass body, etc.) having a central axis 104, a vial plug 110 (e.g., a rubber seal, etc.), a vial seal 115 (e.g., an aluminum seal, a metal seal, etc.) having an upper surface 118. The vial plug 110 may be at least partially integral with the vial seal 115. A sealed vial may also include a vial flip cap 125. A vial flip cap 125 may be at least partially integral with a vial seal 115.

A vial 105 may include a vial neck portion 106 having a vial lip 107 with a vial lip lower surface 108 and a vial lip upper surface 109. The sealed vial 100 may include a vial seal crimp surface 119 that at least partially extends parallel to the lower surface 108 of the vial lip 107 subsequent to the vial seal 115 being crimped onto the vial lip 107

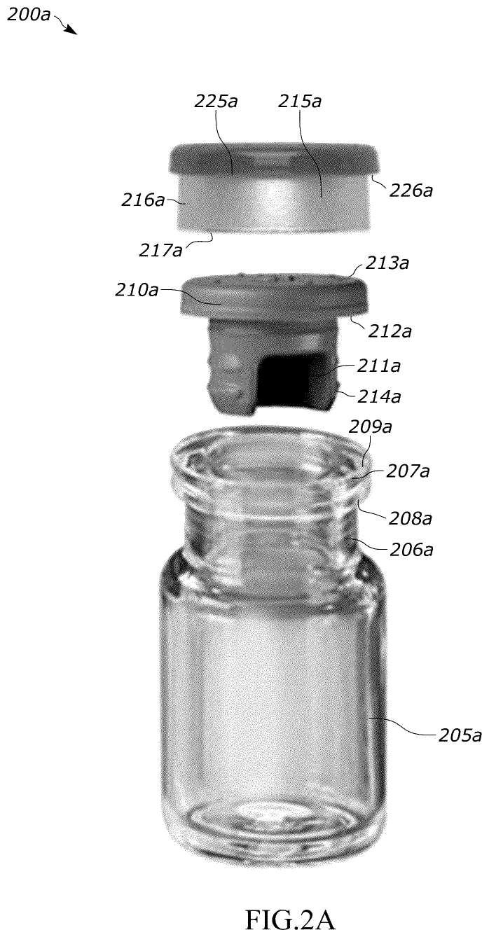

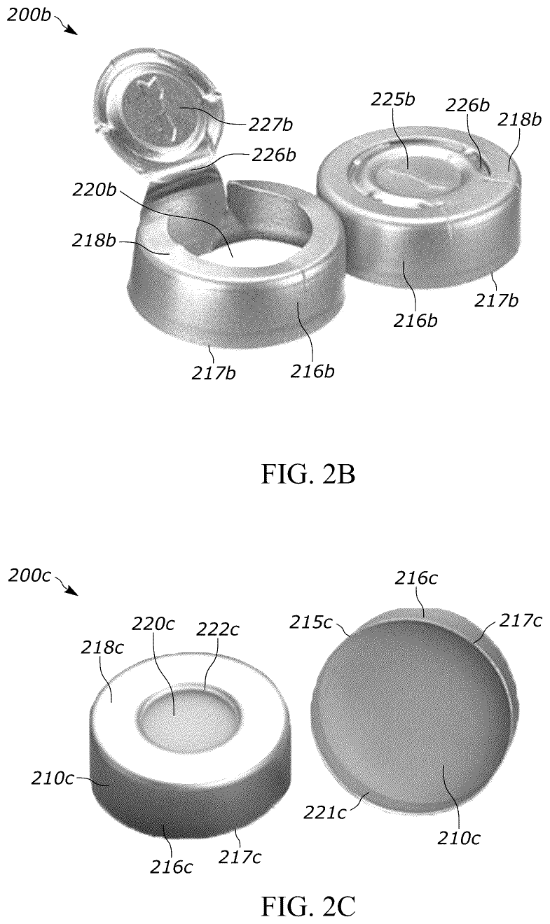

With reference to FIGS. 2A-C, components 200a-c for sealing a vial 205a may include a vial plug 210a,c, a vial seal 215a-c. The vial 205a may include a vial neck portion 206a, a vial lip 207a having a vial lip lower surface 208a and a vial lip upper surface 209a. The vial plug 210a,c may include a vial plug insert portion 211a, a vial plug lip 212a, a vial plug upper surface 213a, 220c, and a vial plug needle insert area 214a, 220c. The vial seal 215a-c may include a vial seal periphery surface 216b-c, a vial seal lower edge 217b-c, a vial seal upper surface 218a-c, a vial seal inner surface 221c, and a vial seal aperture 222c. The vial seal 215b may also include an integral vial flip top 225b,c. The vial flip top 225b,c may include a central portion 225b connected via a hinge 226b. The central portion 225b may be flipped to orientation 227b.

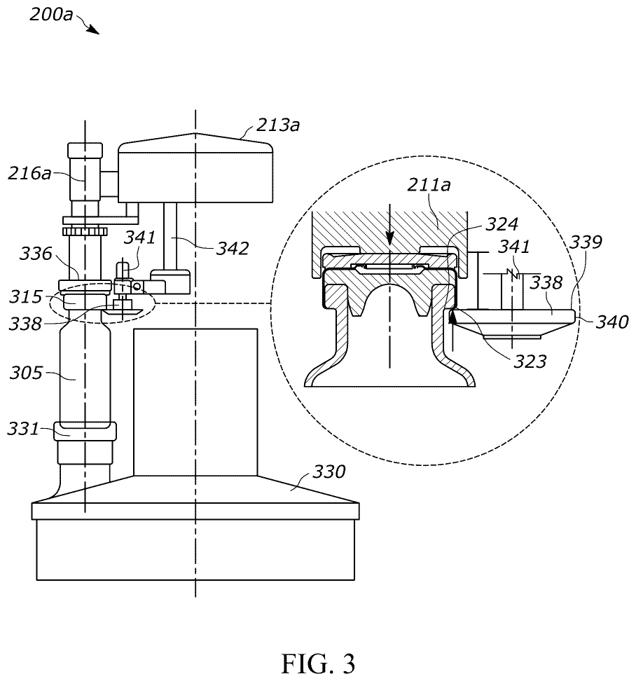

Turning to FIG. 3, a vial seal crimping system 300 may include at least one high speed rotating blade 338

For information purposes, only some details of the vial seal crimping system are included in FIG. 3. The vial seal crimping system 300 may be a mechanical process. The metal blade 338 may move in on the vial seal 315, and may crimp 324 and bend 323 a portion of the vial seal 315 to form a vial seal crimp 119 around the vial lip lower surface 108, 208a. Because a vial seal crimping system 300 may include a highly mechanized process, combined with ongoing variations in the blades 338, and slight variations in vial lip 107, 207a dimensions, the vial seal crimping system 300 may be prone to defects with very few available process adjustments on the crimping process to decrease these defects. The apparatuses, systems, and methods of the present disclosure may incorporated 3D real time vial seal inspection. 3D vial seal inspection may simultaneously minimize false fails and may maximize defect detection when compared to 2D based vial seal crimp inspection.

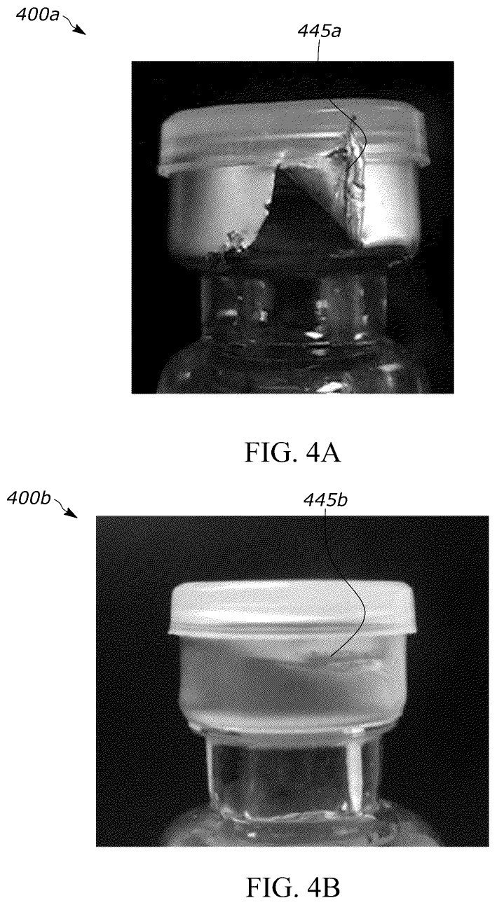

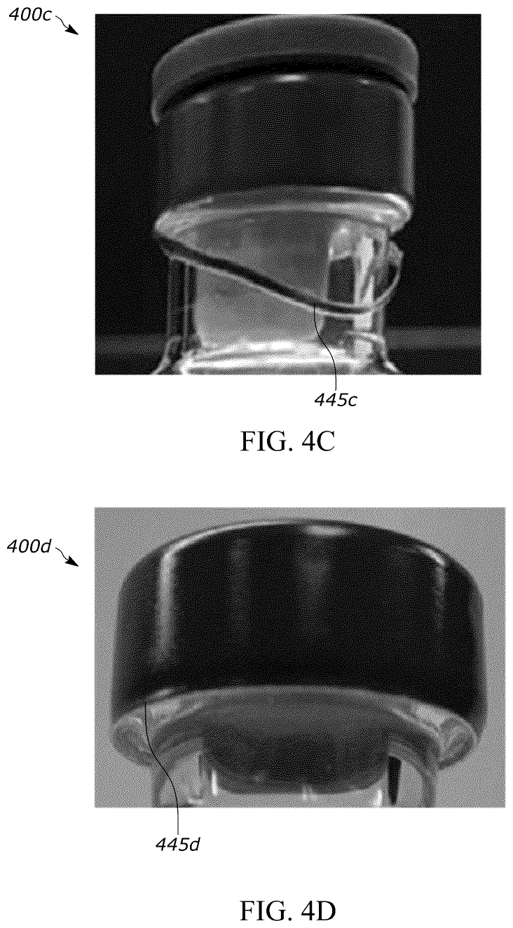

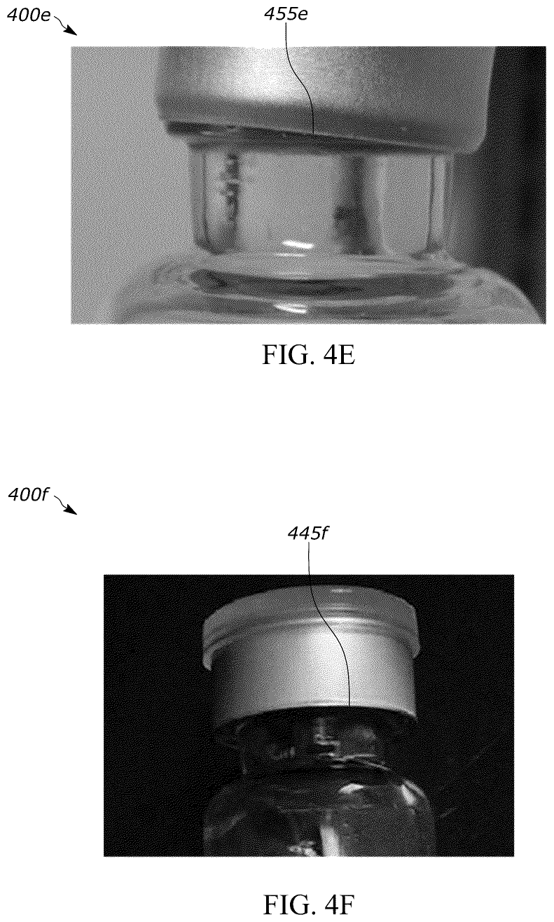

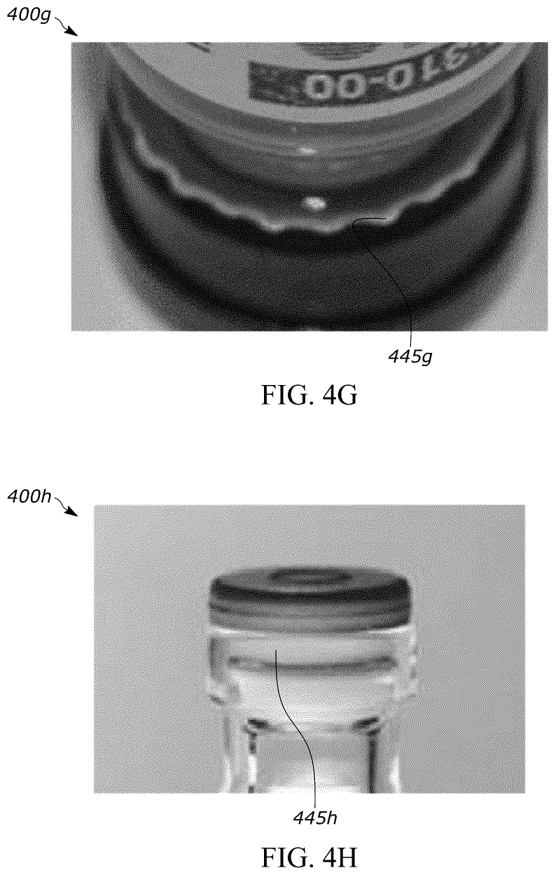

With reference to FIGS. 4A-H, a defective vial seal 400a-h may include at least one defect 445a-h. FIG. 4E depicts a misaligned crimp 445e. FIG. 4F depicts no crimp 445f. FIG. 4G depicts seal rippled 445g with an associated vial inverted and the view looking down on the defective vial seal 400g. FIG. 4H depicts a missing seal 445h.

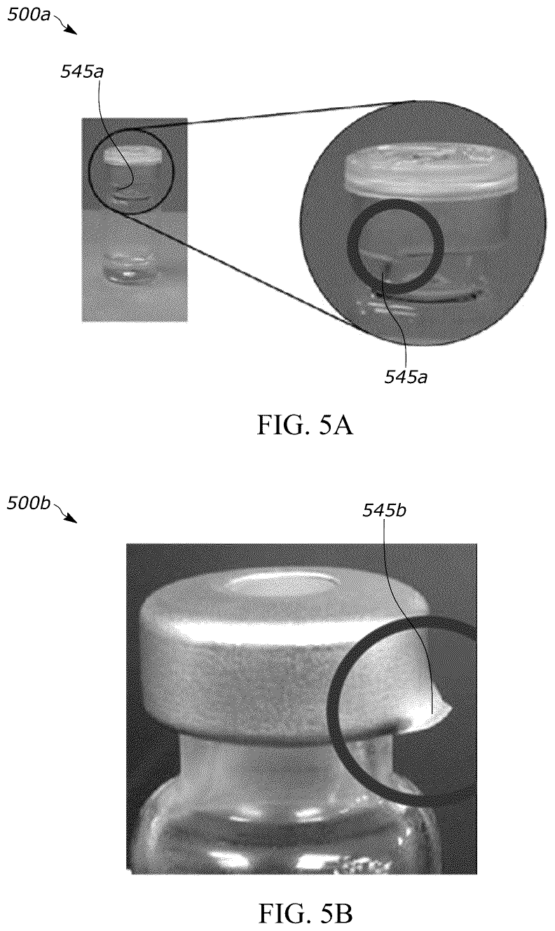

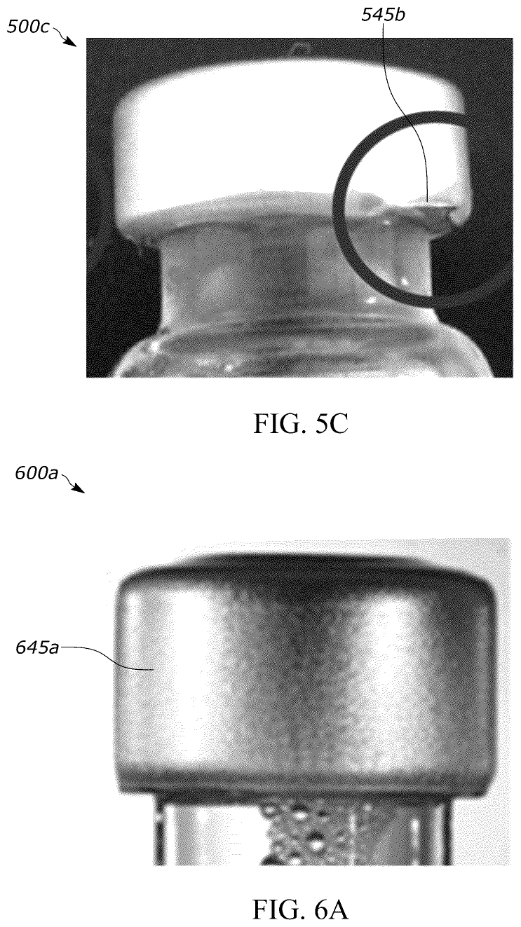

With reference to FIGS. 5A-C, a defective vial seal 500a-c may include a partial seal crimp 545a-c. As described in detail herein, the apparatuses, systems, and methods of the present disclosure may generate vial seal 3D data that is representative of at least a portion of a defective vial seal 400a-h, 500a-c.

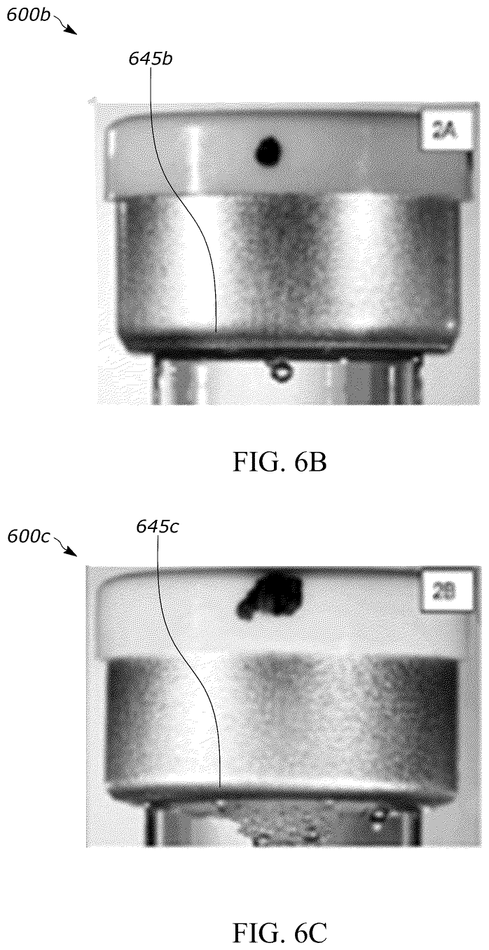

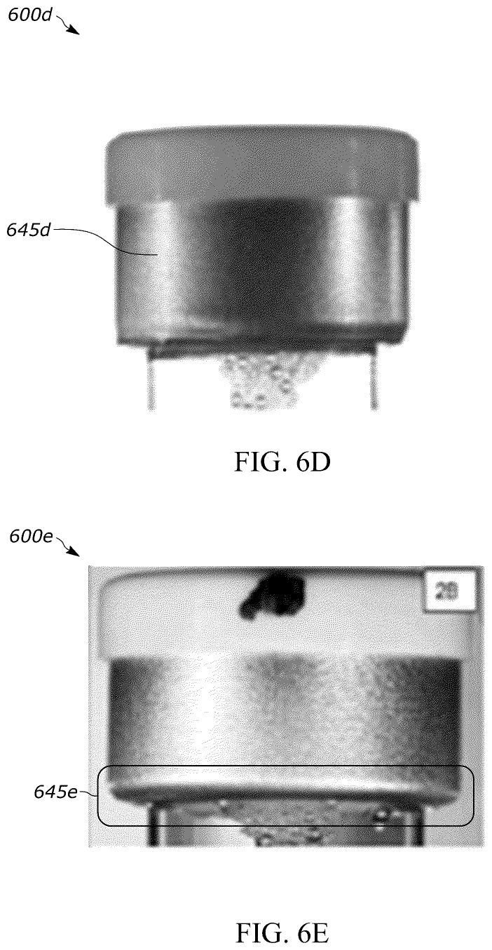

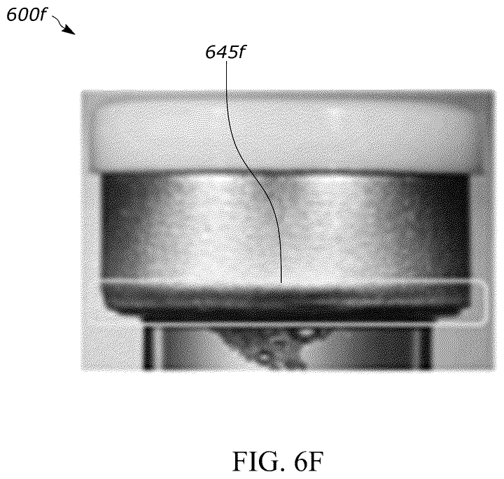

Turning to FIGS. 6A-F, a vial seal 600a-f having an at least partially crimp 645a-f. FIG. 6B depicts a vial seal 600b having a loose crimp 645b. FIG. 6C depicts a vial seal 600c having a non-defective crimp 645c. While a defective seal crimp does not necessarily affect the quality of the drug enclosed in the container, a vial seal 600a-f dropping off in front of a patient, for example, does not give confidence in a related product.

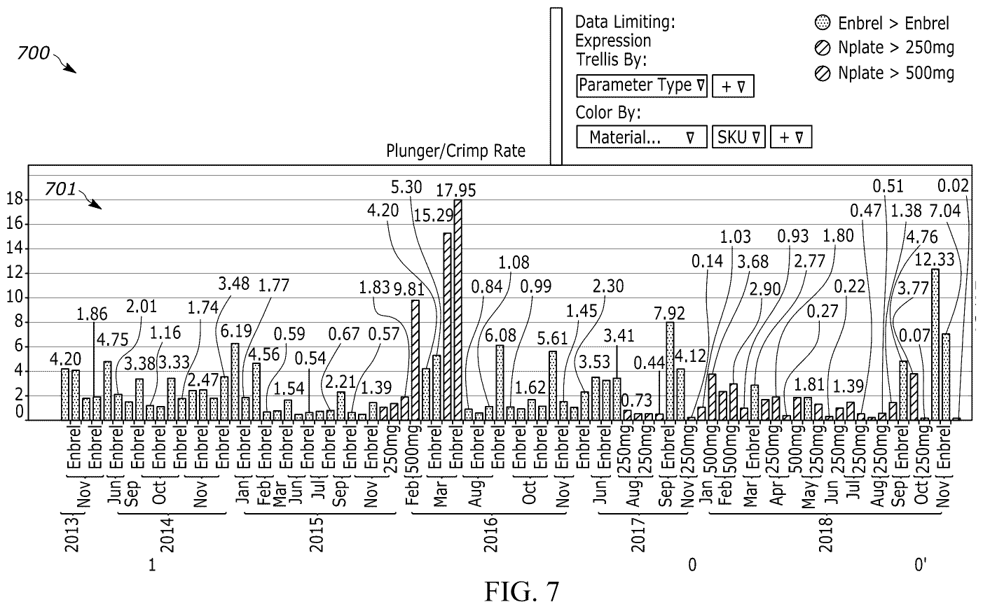

With reference to FIG. 7, vial batch data 700 may illustrate vial seal fails due to 2D crimp inspection. Associated vial inspection may not detect all real vial seal defects, and may mainly include false fails. The graph 701 illustrates vial seal inspections resulting from a traditional 2D camera inspection (i.e., no Z data like in the 3D laser crimp data). False fails included in graph 70a may be prone to illumination issues caused by vial seal batch variations. Graph 701 depicts that a vial seal reject rate as high as 17% has been seen using traditional 2D vial seal crimp inspection. The different grey scales of FIG. 7 may reflect different products, with vial seal crimp styles that may be similar.

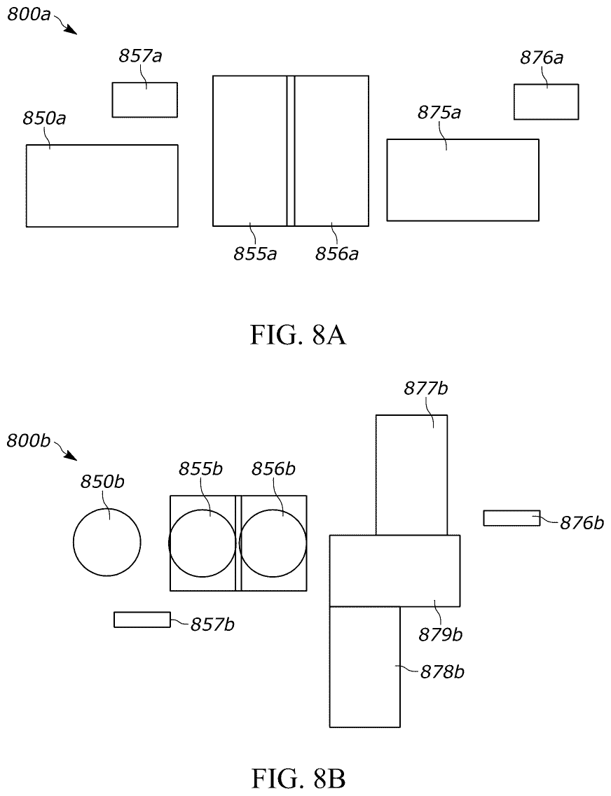

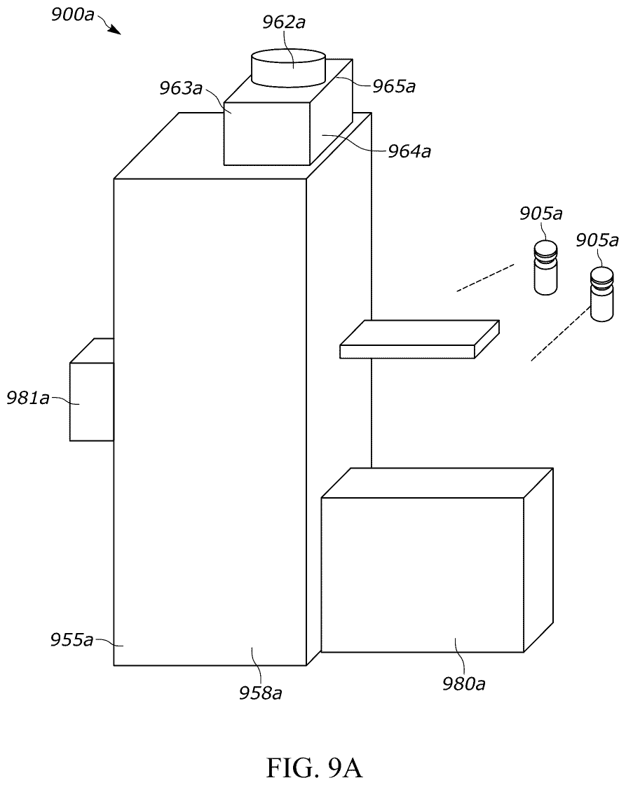

Turning to FIGS. 8A and 8B, a vial seal inspection system 800a,b may include a vial loading turret 850a,b, a first vial seal inspection device 855a,b, a second vial seal inspection device 856a,b, a first man-machine interface 857a,b, an inspected vial collection device 875a, and a second man-machine interface 876a,b. The first and second vial seal inspection devices 855a,b, 856a,b may be configured to provide, for example, two times the vial throughput as compared to a single vial seal inspection devices. The inspected vial collection device 875a may include accepted vial trays 877b, a vial ejection conveyor 878a, and a plurality of vial rejection bins 879b. The 3d Laser heads are installed on the main turrets and from a speed and operational point of view they can be considered as camera stations but with extra data in the Z axis which gives the 3D result.

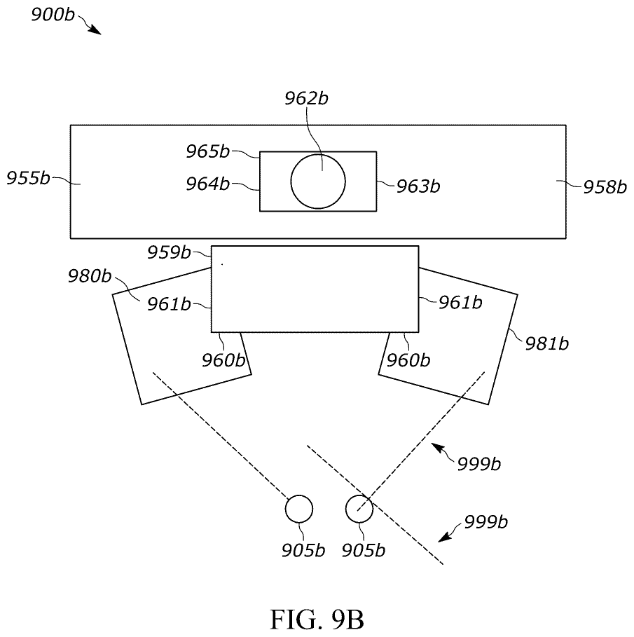

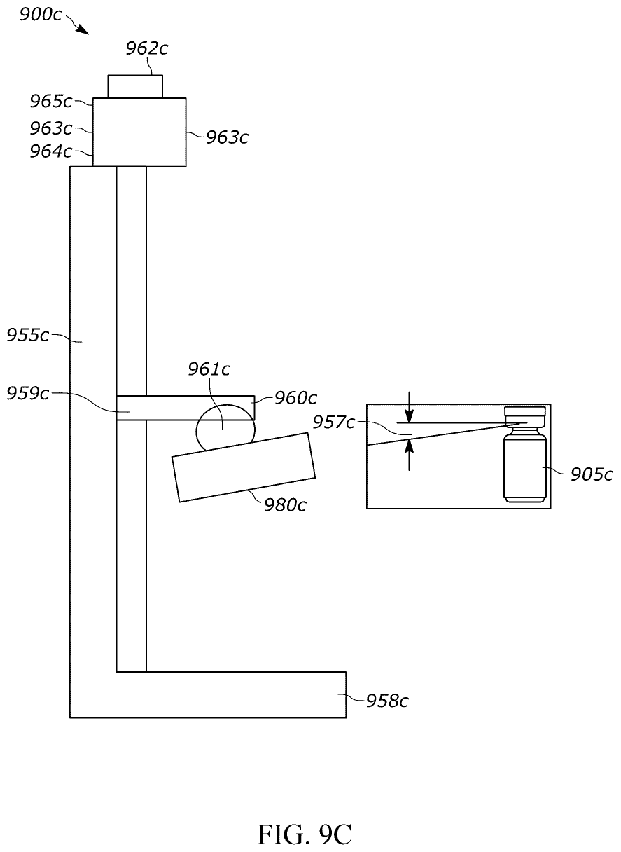

With reference to FIGS. 9A-C, a vial seal inspection system 900a-c may include at least one vial seal inspection device 955a-c having a controller 962a-c with a remote device connection 963a-c, a user input 964a-c and a display 965a-c. A vial seal inspection device 955a-c may include a mounting base 958a-c, an adjustable height support 959a-c having a pivotally connected vial seal distance data generation sensor bracket 960a-c. A vial seal distance data generation sensor perpendicular angle 957c may be indicated with angle gage 961b,c. The vial seal distance data generation sensor perpendicular angle 957c, 961b,c may be representative of an angle between a vial central axis 104 and a line that extends from a vial seal distance data generation sensor near alarm distance point 1091a,b to a vial seal distance data generation sensor far alarm distance point 1092a,b. The vial seal distance data generation sensor angle 957c, 961b,c may be, for example, manually adjusted to include more of, or less of, either a vial seal periphery surface 116 or a vial seal crimp surface 119 in a “field of view” of an associated vial seal distance data generation device 980a-c, 981a,b. The vial seal distance data generation sensor angle 957c, 961b,c may be adjusted to, for example, scan a curved surface 323 of a vial seal crimp which goes under a lip 107 and an upper portion of the vial seal.

A vial seal distance data generation device 980a-c, 981a,b may be configured with an exposure time that is based on a vial seal surface 116, 118, 119 color and/or texture. Details of the exposure times are provided herein with reference to Table 1.

A vial seal distance data generation device incident angle 999a,b may be, for example, representative of an angle between a light emitter central axis 1082a,b and a line that is tangent to a line extending around a periphery surface 116. As described in detail herein, a vial seal distance data generation device incident angle 999a,b may be based on, for example, a color of a surface 116, 119, a texture of a surface 116, 119, a refractive index associated with a coating on surface 116, 119, etc.

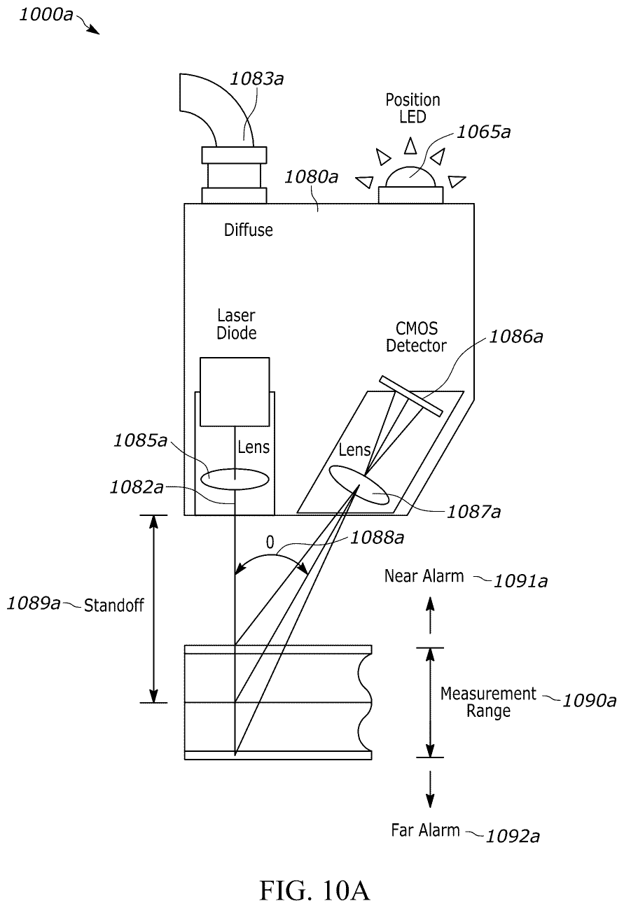

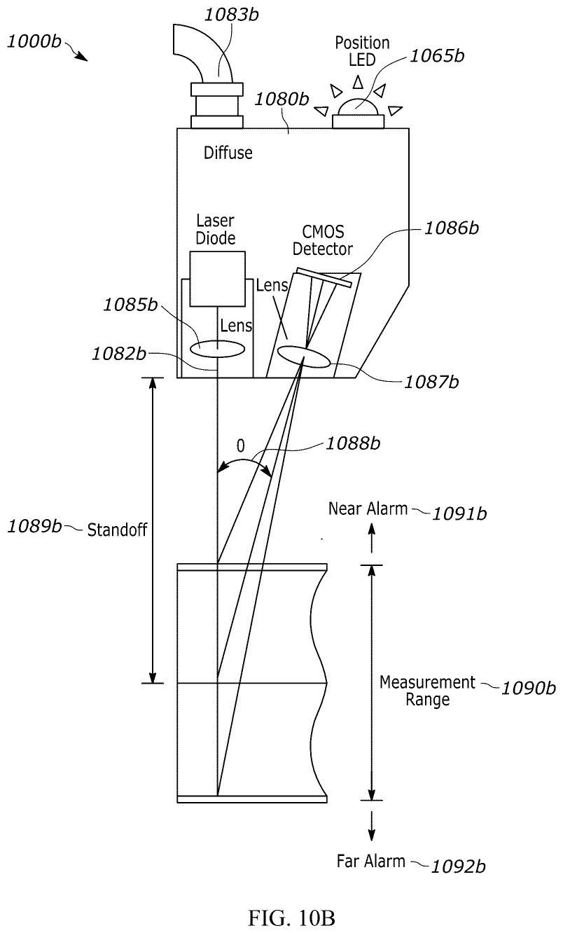

The vial seal inspection device 955a-c may include a first vial seal distance data generation device 980a-c configured to generated vial seal distance data representative of at least a portion of a vial seal of a first vial 905b, a second vial seal distance data generation device 981a,b configured to generated vial seal distance data representative of at least a portion of a vial seal of a second vial 905b. Each vial seal distance data generation devices 980a-c, 981a,b may include, for example, a respective laser triangulation device (e.g., laser triangulation device 1000a,b of FIGS. 10A and 10B, etc.). Each vial seal distance data generation device 980a-c, 981a,b may include a vial seal distance data generation device input connection 983c and a vial seal distance data generation device output connection 984c.

Two vial seal distance data generation devices 980a-c, 981a,b may be configured to, for example, provide dual vial seal inspection (e.g., 400 vials per minute, etc.). The user interface 964a-c may include three buttons configured to, for example, indicate a height (e.g., standoff height 1089a,b of FIGS. 10A and 10B, etc.) of an associated vial seal distance data generation device 980a-c, 981a,b with respect to, for example, a vial seal crimp 119; this may result in an accurate measurement range 1090a,b. A measurement range 1090a,b may be different for different vial seals 115 (e.g., smaller vial seals, larger vial seals, etc.) and/or different vials 105 (e.g., a smaller vial, a larger vial, etc.). Additionally, the vial seal inspection device 955a-c may be configured with fail safe height thresholds (i.e., if the height 1082a,b is not right for a particular vial being inspected, the vial seal inspection device 955a-c may provide an alert or a device stop, etc.).

During a vial seal inspection the vial seal inspection sensors 980a-c, 981c may, for example, not move relative to a vial being inspected (i.e., the vial may rotate relative the vial seal inspection sensors 980a-c, 981c, etc.). For example, internal optics of a vial seal inspection sensors 980a-c may scan a full surface of a vial seal crimp surface 119 and at least a portion of a vial seal periphery surface 116. Scanning of a vial seal may be internal to the vial seal inspection sensors 980a-c, 981c. A pre-determined Z-axis “zero” value may be set for height 1082a,b by, for example, manually turning a knob on the vial seal inspection sensors 980a-c, 981c. A vial seal inspection sensor 980a-c, 981c may be fixed at a particular location for a full vial seal inspection batch. Alternatively, or additionally, a Z-axis “zero” value may be automatically and/or dynamically for height 1082a,b based on, for example, a feedback signal of an associated zero height sensor.

A standoff height 1089a,b may be set once at a start of a batch by a setup technician. This height may be correlated with, for example, a vial stock-keeping unit (SKU). When the turret of the main AVI system rotates two new vials enter the inspection area. The head is stationary at this point and the vial rotates at a preset RPM to enable a predetermined number of scans to be achieved over a desired vial seal perimeter (e.g., 360 degrees, etc.). A vial seal rotation speed and/or a number of vial seal scans per rotation may be based on, for example, a vial inspection rate (i.e., vials inspected per second), an acceptable Z-axis distance tolerance, a desired resolution of associated vial seal 3D data, etc.

Turning to FIGS. 10A and 10B, a vial seal distance data generation device 1000a,b (e.g., a laser triangulation sensor, a Micro-Epsilon LLT2657-50 laser triangulation sensor as available from scancontrol, etc.) may include a housing 1080a,b, an input/output connection 1083a,b, an output 1065a,b (alternatively, or additionally an output connection 984c), a light source central axis 1082a,b, light source optics 1085a,b, a light sensor 1086a,b, light sensor optics 1087a,b, a scan line angle 1088a,b, a standoff height 1089a,b, a measurement range 1090a,b, a near alarm 1091a,b, and a far alarm 1092a,b. The vial seal distance data generation device 1000a,b may be configure to output, for example, a vial seal distance data that is representative of Y-data values correlated with Z-axis data.

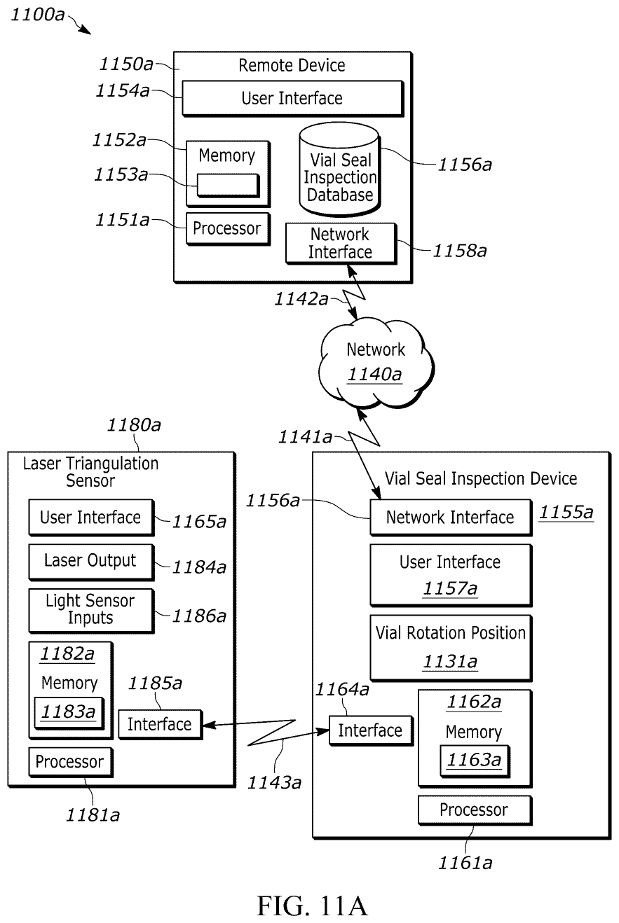

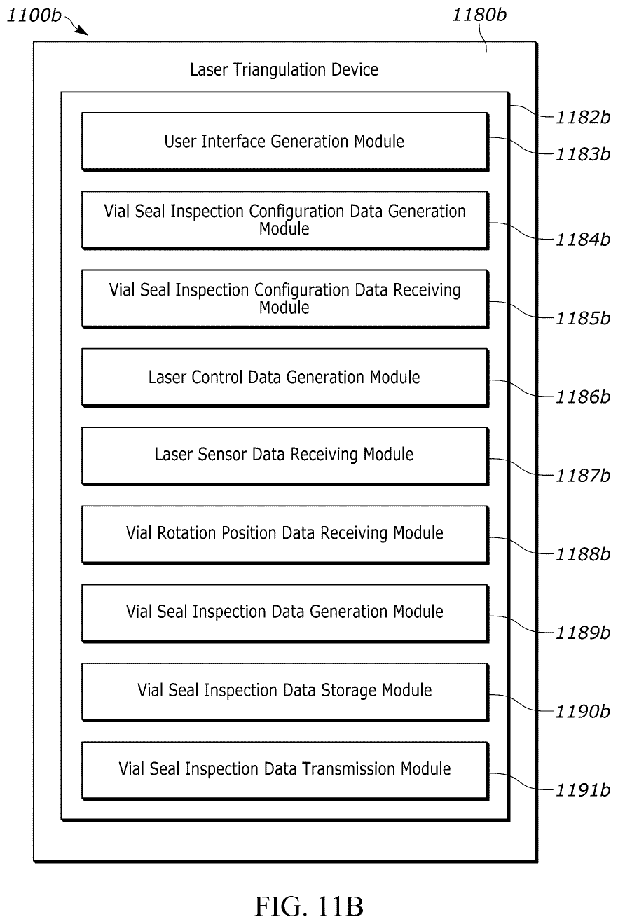

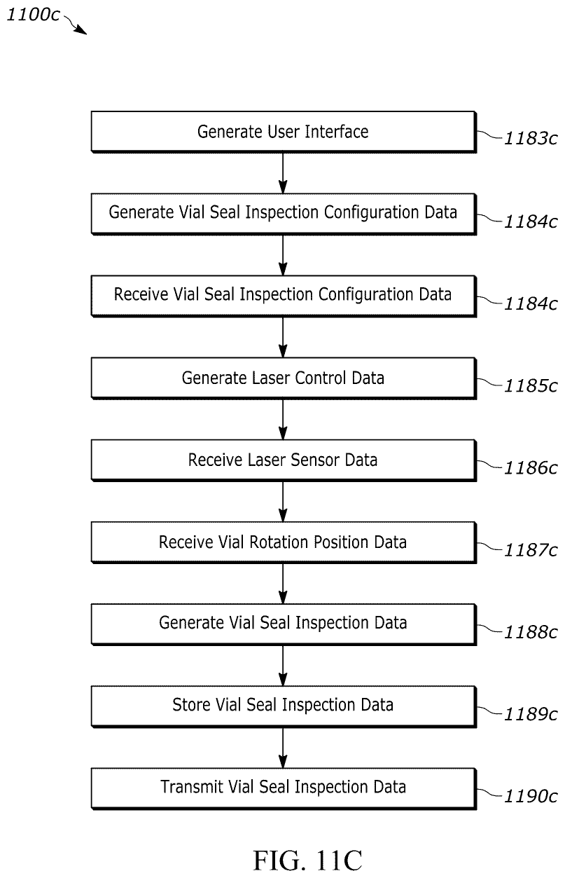

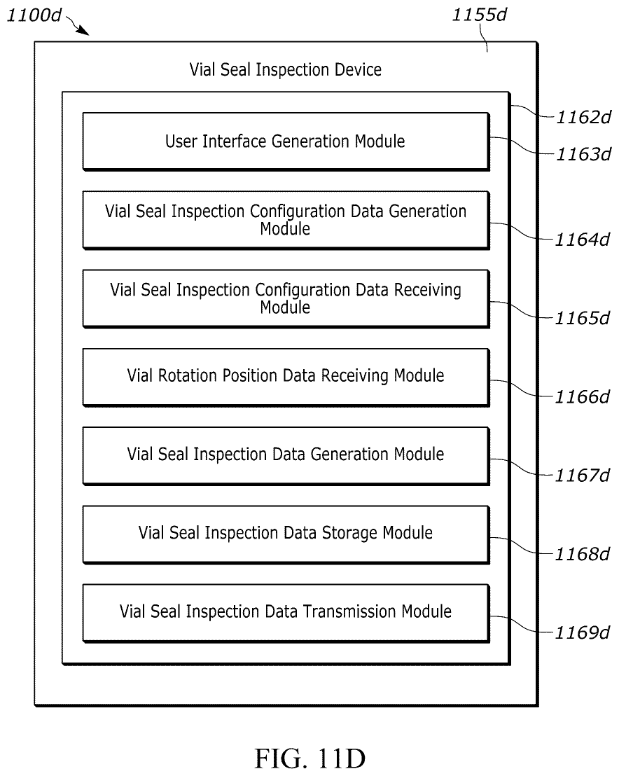

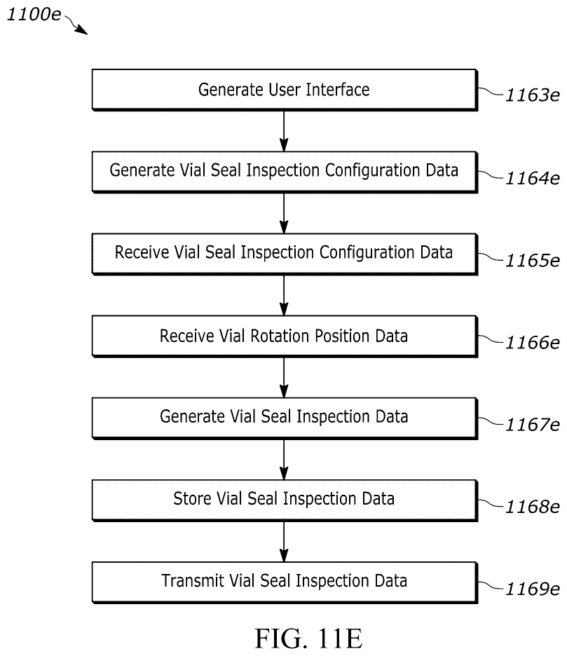

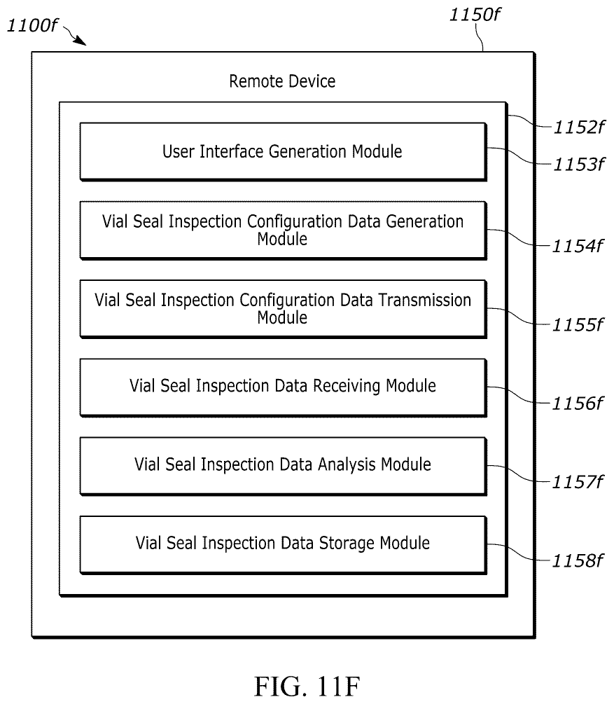

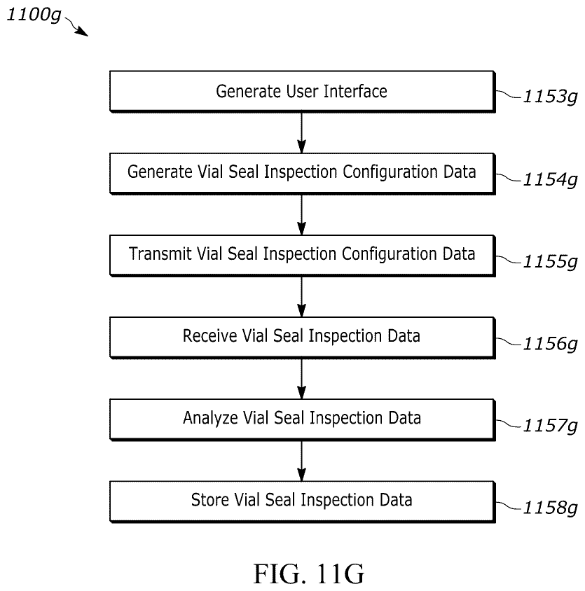

While not shown in FIGS. 10A and 10B, a vial seal distance data generation device 1000a,b may also include a memory (e.g., memory 1182a of FIG. 11A) and/or a processor (e.g., processor 1181a of FIG. 11A). A vial seal distance data generation device 1000a,b with memory 1182a and processor 1181a may be configured to process Y-axis data and Z-axis data, and subsequently provide processed Y-axis data and/or processed Z-axis data to a vial seal distance data generation device controller 962a-c. The vial seal distance data generation device 1000a,b may be configure to output, for example, a binary indication of whether a given vial seal is acceptable or not. Alternatively, or additionally, the vial seal distance data generation device 1000a,b may be configure to output, for example, a continuous range of values indicative of a probability (a likelihood) of whether a given vial seal is acceptable (e.g., 0-100%, greater than zero percent and less than one-hundred percent, etc.).

With two vial seal distance data generation devices 1000a,b, an associated vial seal inspection system 800a,b may be configured to inspect vial sizes of, for example, 4 cc and 5 cc at speeds of 400 vials per min, 20 cc and 30 cc at speeds of 333 vials per minute, and 50 cc at approx. 200 vials per minute. A scan speed may be based on a respective resolution.

A laser beam 1082a,b may be projected on vial seal being measured 115, and a portion of the laser beam may be reflected through optics onto a detector 1086a,b. As a distance (i.e., a Z-axis distance) from the vial seal distance data generation devices 1000a,b to the vial seal 115 changes, the laser beam 1082a,b proportionally moves on the detector 1086a,b focusing the beam and calculating a relative distance to the vial seal correlated with respective Y-axis data.

A number of scans per time period may be pre-determined. A vial seal distance data generation device 1000a,b specification may include a scan rate. To achieve one scan, a laser may send out a laser beam 1082a,b over a one scan vertical (Y-axis) area. The a vial seal distance data generation device 1000a,b may then wait for the laser light to return to the light sensor 1086a,b. The a vial seal distance data generation device 1000a,b may the perform calculations (e.g., triangulation calculations, etc.) on depth (Z-axis). Light emission, light sensing, and distance calculations may occur at the speed of light. A vial seal distance data generation device 1000a,b may be selected for a vial seal surface 116 color (e.g., a gray vial seal surface 116, a blue vial seal surface 116, etc.).

With reference to FIG. 11A, a vial seal inspection system 1100a may include a vial seal inspection device 1155a having at least one vial seal distance data generation device 1180a (e.g., a laser triangulation sensor, a sonic sensor, etc.), and a remote device 1150a communicatively interconnected via a network 1140a. The vial seal inspection system 1100a may be similar to, for example, the vial seal inspection system 800a,b of FIGS. 8A and 8B. The vial seal distance data generation device 1180a may be similar to, for example, the vial seal distance data generation sensor 1000a,b of FIG. 10 or the vial seal distance data generation device 900a-c. The remote device 1150a may be similar to, for example, either one of the man-machine interfaces 857a,b or 876a,b of FIGS. 8A and 8B.

For clarity, only one vial seal inspection device 1155a, one vial seal distance data generation device 1180a, and one remote device 1150a are depicted in FIG. 11A. While FIG. 11A depicts only one vial seal inspection device 1155a, one vial seal distance data generation device 1180a, and one remote device 1150a, it should be understood that any number of vial seal inspection devices 1155a, vial seal distance data generation devices 1180a, and remote devices 1150a may be supported by the vial seal inspection system 1100a.

A vial seal inspection device 1155a may include a memory 1162a and a processor 1161a for storing and executing, respectively, a module 1163a. The module 1163a, stored in the memory 1162a as a set of computer-readable instructions, may be related to an application for implementing at least a portion of the vial seal inspection system 1100a. As described in detail herein, the processor 1161a may execute the module 1163a to, among other things, cause the processor 1161a to receive, generate, and/or transmit data (e.g., vial seal inspection sensor configuration data, vial seal inspection device configuration data, vial seal 3D data, etc.) with the remote device 1150a.

The vial seal inspection device 1155a may also include a user interface 1157a which may be any type of electronic display device, such as touch screen display, a liquid crystal display (LCD), a light emitting diode (LED) display, a plasma display, a cathode ray tube (CRT) display, or any other type of known or suitable electronic display along with a user input device. A user interface 1157a may exhibit a user interface display which may, for example, depict a user interface for implementation of at least a portion of the vial seal inspection system 1100a.

The vial seal inspection device 1155a may also include a vial rotation position input 1131a, a network interface 1156a, and an interface 1164a configured to, for example, communicate vial seal inspection sensor configuration data, vial seal distance data, vial seal 3D data, etc. with the vial seal distance data generation sensor 1180a. The network interface 1156a may be configured to, for example, facilitate communications, for example, between the vial seal inspection device 1155a and the network device 1140a via any wireless communication network 1141a, including for example: a wireless LAN, MAN or WAN, WiFi, TLS v1.2 WiFi, the Internet, or any combination thereof. Moreover, a stationary telepresence device 205a may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

A vial seal distance data generation device 1180a may be similar to, for example, vial seal distance data generation sensor 1000a,b of FIGS. 10A and 10B. As described with reference to FIGS. 10A and 10B, a vial seal distance data generation device 1180a may include a memory 1182a and a processor 1181a for storing and executing, respectively, a module 1183a. The module 1183a, stored in the memory 1182a as a set of computer-readable instructions, may be related to an application for implementing at least a portion of the vial seal inspection system 1100a. As described in detail herein, the processor 1181a may execute the module 1183a to, among other things, cause the processor 1181a to receive, generate, and/or transmit data (e.g., camera control data, mobile base control data, video data, etc.) with the vial seal inspection device 1155a and/or directly with a remote device 1150a.

The vial seal distance data generation device 1180a may also include a user interface 1165a which may be any type of electronic display device, such as touch screen display, a liquid crystal display (LCD), a light emitting diode (LED) display, a plasma display, a cathode ray tube (CRT) display, or any other type of known or suitable electronic display along with a user input device. A user interface 1165a may exhibit a user interface display which may, for example, depict a user interface for implementation of at least a portion of the vial seal inspection system 1100a.

The vial seal distance data generation device 1180a may also include a light source output 1184a, a light sensor input 1186a, and an interface 1185a configured to, for example, communicate vial seal inspection sensor configuration data, vial seal distance data, vial seal 3D data, etc. with the vial seal inspection device 1155a. Moreover, a vial seal distance data generation device 1180a may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

A remote device 1150a may include a memory 252a and a processor 251a for storing and executing, respectively, a module 253a. The module 253a, stored in the memory 1152a as a set of computer-readable instructions, may be related to an application for implementing at least a portion of the vial seal inspection system 1100a. As described in detail herein, the processor 1151a may execute the module 1153a to, among other things, cause the processor 1151a to receive, generate, and/or transmit data (e.g., vial seal distance data sensor configuration data, vial seal distance data device configuration data, vials seal inspection data, vial seal distance data, vial seal 3D data, etc.) with the network device 1140a.

The remote device 1150a may also include a user interface 1154a which may be any type of electronic display device, such as touch screen display, a liquid crystal display (LCD), a light emitting diode (LED) display, a plasma display, a cathode ray tube (CRT) display, or any other type of known or suitable electronic display along with a user input device. A user interface 1154a may exhibit a user interface display which may, for example, depict a user interface for implementation of at least a portion of the vial seal inspection system 1100a.

The remote device 1150a may also include a network interface 257a configured to facilitate communications (e.g., vial seal distance data sensor configuration data, vial seal distance data device configuration data, vials seal inspection data, vial seal distance data, vial seal 3D data, etc.), for example, between the remote device 1150a and the network device 1140a via any wireless communication network 1142a, including for example: TLS v1.2 REST API, TLS v1.2 Cellular, CSV/JSON Output, TLS v1.2 REST API, a wireless LAN, MAN or WAN, WiFi, TLS v1.2 WiFi, the Internet, or any combination thereof. Moreover, a remote device 1150a may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

Turning to FIG. 11B, a vial seal inspection system 1100b may include a vial seal distance data generation device 1180b having a user interface generation module 1183b, a vial seal inspection configuration data generation module 1184b, a vial seal inspection configuration data receiving module 1185b, a laser control data generation module 1186b, a laser sensor data receiving module 1187b, a vial rotation position data receiving module 1188b, a vial seal inspection data generation module 1189b, a vial seal inspection data storage module 1190b, and a vial seal inspection data transmission module 1191b, for example, stored on a memory 1182b as a set of computer-readable instructions. In any event, the modules 1183b-1191b may be similar to, for example, the module 1183a of FIG. 11A.

With reference to FIG. 11C, a method of implementing a vial seal distance data generation device 1100c may be implemented by a processor (e.g., processor 1181a of FIG. 11A) executing, for example, at least a portion of modules 1183b-1191b of FIG. 11B. In particular, processor 1181a may execute the user interface generation module 1183b to cause the processor 1181a to, for example, generate a user interface (block 1183c).

The processor 1181a may execute the vial seal inspection configuration data generation module 1184b to cause the processor 1181a to, for example, generate vial seal inspection configuration data (block 1184c). Vial seal inspection configuration data may include one or more of: a vial identification, a vial seal identification, a vial seal distance data generation device identification, a vial seal crimping system identification, a Z-axis tolerance threshold (e.g., a near alarm 1091a,b, a far alarm 1092a,b, etc.), an X-axis measurement range, a Y-axis measurement range, a Z-axis measurement range, a vial seal distance data generation sensor stand off-height, a vial seal distance data generation sensor exposure time, a vial seal distance data generation sensor scan rate, a vial seal distance data generation sensor incident angle, vial seal distance data generation sensor perpendicular angle, a vial rotation rate, vial physical dimensions, vial seal physical dimensions, a vial seal surface texture, a vial seal surface color, a vial seal surface coating thickness, a vial seal surface coating material, etc. The processor 1181a may execute the vial seal inspection configuration data receiving module 1185b to cause the processor 1181a to, for example, receive vial seal inspection configuration data (block 1185c).

The processor 1181a may execute the laser control data generation module 1186b to cause the processor 1181a to, for example, generate laser control data (block 1186c). For example, the processor 1181a may generate laser control data based on a vial seal distance data generation sensor exposure time, a vial seal distance data generation sensor scan rate, etc. The processor 1181a may execute the laser sensor data receiving module 1187b to cause the processor 1181a to, for example, receive laser sensor data (block 1187c). For example, the processor 1181a may receive laser sensor data from a light sensor 1186a,b.

The processor 1181a may execute the vial rotation position data receiving module 1188b to cause the processor 1181a to, for example, receive vial rotation data (block 1188c). The vial seal rotation position data (i.e., vial seal periphery data, X-axis data, etc.) may be, for example, pre-determined (e.g., vial seal periphery data may be based on a perimeter length of at least a portion of a vial seal, vial seal periphery data may be based on a vial rotation time, etc.), and may be manually entered via a user interface 1165a. Alternatively, or additionally, the vial seal rotation position data may be generated via, for example, a feedback sensor output. Feedback sensor output data (i.e., X-axis data) may be directly correlated with respective Y-axis data, and Z-axis data. More broadly, processor 1181a may generate vial seal 3D data based on correlating Y-axis data and Z-axis data, from a vial seal distance data generation sensor, with X-axis data, that may be representative of points along at least a portion of a perimeter of a vial seal.

The processor 1181a may execute the vial seal inspection data generation module 1189b to cause the processor 1181a to, for example, generate vial seal inspection data (block 1189c). The vial seal inspection data may be representative to, for example, Y-axis data, Z-axis data, vial seal 3D data, a vial seal acceptable, a vial seal reject, a probability that a vial seal is acceptable, a probability that a vial seal crimp is acceptable, etc. Additionally, or alternatively, the processor 1181a may generate vial seal inspection data based on a comparison of a current Z-axis value with a Z-axis tolerance threshold.

The processor 1181a may execute the vial seal inspection data storage module 1190b to cause the processor 1181a to, for example, store vial seal inspection data (block 1190c). The processor 1181a may execute the vial seal inspection data transmission module 1191b to cause the processor 1181a to, for example, transmit vial seal inspection data (block 1191c). For example, the processor 1181a may transmit vial seal inspection data to remote device 1150a and/or a vial seal inspection device 1155a.

With reference to FIG. 11D, a vial seal inspection system 1100d may include a vial seal inspection device 1155d having a user interface generation module 1163d, a vial seal inspection configuration data generation module 1164d, a vial seal inspection configuration data receiving module 1165d, a vial rotation position data receiving module 1166d, a vial seal inspection data generation module 1167d, a vial seal inspection data storage module 1168d, and a vial seal inspection data transmission module 1169d, for example, stored on a memory 1162d as a set of computer-readable instructions. In any event, the modules 1163d-1169d may be similar to, for example, the module 1163a of FIG. 11A.

With reference to FIG. 11E, a method of implementing a vial seal inspection device may be implemented by a processor (e.g., processor 1161a of FIG. 11A) executing, for example, at least a portion of modules 1163d-1169d of FIG. 11D. In particular, processor 1161a may execute the user interface generation module 1163d to cause the processor 1161a to, for example, generate a user interface (block 1163e).

The processor 1161a may execute the vial seal inspection configuration data generation module 1164d to cause the processor 1161a to, for example, receive generate vial seal inspection configuration data (block 1164e). Vial seal inspection configuration data may include one or more of: a vial identification, a vial seal identification, a vial seal distance data generation device identification, a vial seal crimping system identification, a Z-axis tolerance threshold (e.g., a near alarm 1091a,b, a far alarm 1092a,b, etc.), an X-axis measurement range, a Y-axis measurement range, a Z-axis measurement range, a vial seal distance data generation sensor stand off-height, a vial seal distance data generation sensor exposure time, a vial seal distance data generation sensor scan rate, a vial seal distance data generation sensor incident angle, vial seal distance data generation sensor perpendicular angle, a vial rotation rate, vial physical dimensions, vial seal physical dimensions, a vial seal surface texture, a vial seal surface color, a vial seal surface coating thickness, a vial seal surface coating material, etc.

The processor 1161a may execute the vial seal inspection configuration data receiving module 1165d to cause the processor 1161a to, for example, receive vial seal inspection configuration data (block 1165e). For example, the processor 1161a may receive vial seal inspection configuration data from a remote device 1150a.

The processor 1161a may execute the vial rotation position data receiving module 1166d to cause the processor 1161a to, for example, receive vial rotation position data (block 1166e). Vial seal rotation position data (i.e., vial seal periphery data, X-axis data, etc.) may be, for example, pre-determined (e.g., vial seal periphery data may be based on a perimeter length of at least a portion of a vial seal, vial seal periphery data may be based on a vial rotation time, etc.), and may be manually entered via a user interface 1157a. Alternatively, or additionally, the vial seal rotation position data may be generated via, for example, a feedback sensor output. Feedback sensor output data (i.e., X-axis data) may be directly correlated with respective Y-axis data, and Z-axis data. More broadly, processor 1161a may generate vial seal 3D data based on correlating Y-axis data and Z-axis data, from a vial seal distance data generation sensor, with X-axis data, that may be representative of points along at least a portion of a perimeter of a vial seal.

The processor 1161a may execute the vial seal inspection data generation module 1167d to cause the processor 1161a to, for example, generate vial seal inspection data (block 1167e). The vial seal inspection data may be representative to, for example, Y-axis data, Z-axis data, vial seal 3D data, a vial seal acceptable, a vial seal reject, a probability that a vial seal is acceptable, a probability that a vial seal crimp is acceptable, etc. Additionally, or alternatively, the processor 1161a may generate vial seal inspection data based on a comparison of a current Z-axis value with a Z-axis tolerance threshold.

The processor 1161a may execute the vial seal inspection data storage module 1168d to cause the processor 1161a to, for example, store vial seal inspection data (block 1168e). The processor 1161a may execute the vial seal inspection data transmission module 1169d to cause the processor 1161a to, for example, transmit vial seal inspection data (block 1169e).

Turning to FIG. 11F, a vial seal inspection system 1100f may include a remote device 1150f having a user interface generation module 1153f, a vial seal inspection configuration data generation module 1154f, a vial seal inspection configuration data transmission module 1155d, a vial seal inspection data generation module 1156f, a vial seal inspection data storage module 1157f, and a vial seal inspection data transmission module 1158f, for example, stored on a memory 1162d as a set of computer-readable instructions. In any event, the modules 1153f-1158f may be similar to, for example, the module 1153a of FIG. 11A.

With reference to FIG. 11G, a method of implementing a remote device 1100g may be implemented by a processor (e.g., processor 1151a of FIG. 11A) executing, for example, at least a portion of modules 1153f-1158f of FIG. 2F. In particular, processor 1151a may execute the user interface generation module 1153f to cause the processor 1151a to, for example, generate a user interface (block 1153g).

The processor 1151a may execute the vial seal inspection configuration data generation module 1154f to cause the processor 1151a to, for example, generate vial seal inspection configuration data (block 1154g). Vial seal inspection configuration data may include one or more of: a vial identification, a vial seal identification, a vial seal distance data generation device identification, a vial seal crimping system identification, a Z-axis tolerance threshold (e.g., a near alarm 1091a,b, a far alarm 1092a,b, etc.), an X-axis measurement range, a Y-axis measurement range, a Z-axis measurement range, a vial seal distance data generation sensor stand off-height, a vial seal distance data generation sensor exposure time, a vial seal distance data generation sensor scan rate, a vial seal distance data generation sensor incident angle, vial seal distance data generation sensor perpendicular angle, a vial rotation rate, vial physical dimensions, vial seal physical dimensions, a vial seal surface texture, a vial seal surface color, a vial seal surface coating thickness, a vial seal surface coating material, etc. The processor 1151a may execute the vial seal inspection configuration data transmission module 1155f to cause the processor 1151a to, for example, transmit vial seal inspection configuration data to a vial seal inspection sensor 1180a or a vial seal inspection device 1155a (block 1155g).

The processor 1151a may execute the vial seal inspection data receiving module 1156f to cause the processor 1151a to, for example, receive vial seal inspection data (block 1156g). For example, the process 1151a may receive vial seal inspection data from a vial seal inspection sensor 1180a or vial seal inspection device 1155a. The vial seal inspection data may be representative to, for example, Y-axis data, Z-axis data, vial seal 3D data, a vial seal acceptable, a vial seal reject, a probability that a vial seal is acceptable, a probability that a vial seal crimp is acceptable, etc. Additionally, or alternatively, the processor 1151a may generate vial seal inspection data based on a comparison of a current Z-axis value with a Z-axis tolerance threshold.

The processor 1151a may execute the vial seal inspection data analysis module 1158f to cause the processor 1151a to, for example, analyze vial seal inspection data (block 1158g). For example, the processor 1151a may determine a number of false fails based on the vial seal inspection data. The processor 1151a may execute the vial seal inspection data storage module 1157f to cause the processor 1151a to, for example, store vial seal inspection data in a vial seal inspection database 1156a (block 1158g).

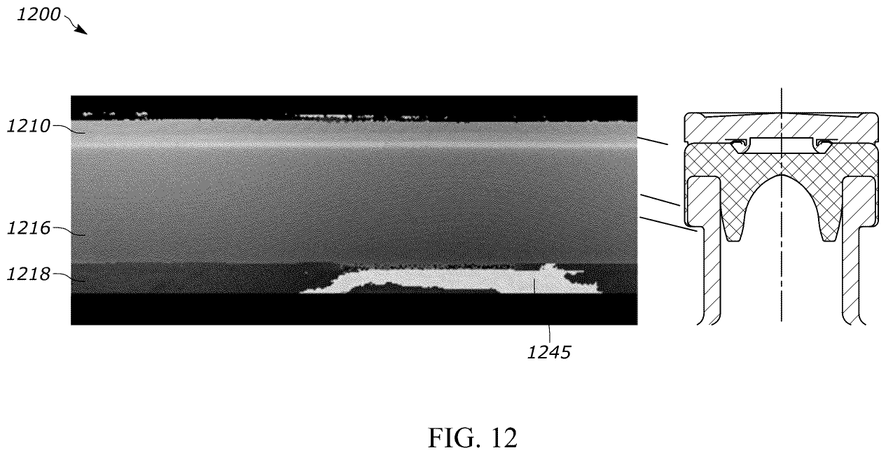

Turning to FIG. 12, an “unwrapped image” of a 360 degree 3D profile view of a vial seal 1200. The gray scale in the image is representative of Z-axis data. Example the vial seal crimp portion 1218 is representative of a crimp going around a vial lip 117. A processor 1181a may generate vial seal 3D data that is representative of a vial seal defect 1245. Additionally, or alternatively, processor 1181a may generate vial seal 3D data that is representative of a vial seal crimp angle (or how much of the vial seal is actually crimped) based on X-axis data, Y-axis data, and Z-axis data. The processor 1181a may generate vial seal 3D data that is representative of a vial seal upper portion 1210 and/or a vial seal periphery surface 1216 based on X-axis data, Y-axis data, and Z-axis data.

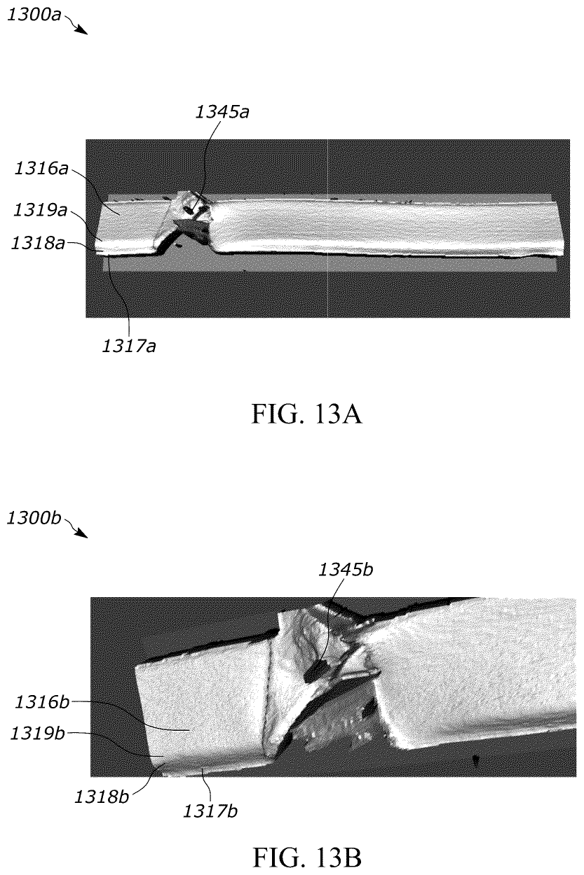

With reference to FIGS. 13A and 13B, a three-dimensional model 1300a,b of a vial seal may include a vial seal periphery surface 1316a,b, a vial seal lower edge 1317a,b, a vial seal crimp surface 1318a,b, a vial seal crimp angle 1319a,b, and a damaged vial seal area 1345a,b. The three-dimensional model 1300a,b and/or the damaged vial seal area 1345a,b may be based on, for example, on X-axis data, Y-axis data, and Z-axis data.

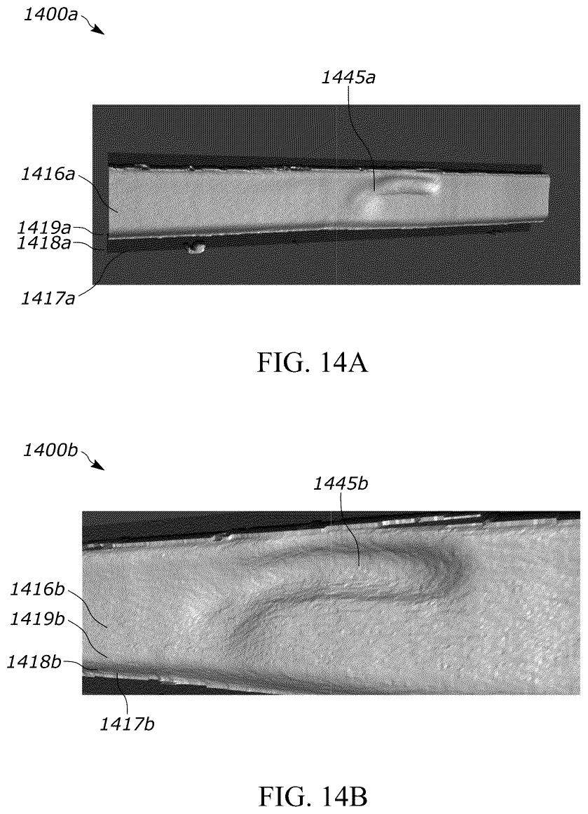

Turning to FIGS. 14A and 14B, a three-dimensional model 1400a,b of a vial seal may include a vial seal periphery surface 1416a,b, a vial seal lower edge 1417a,b, a vial seal crimp surface 1418a,b, a vial seal crimp angle 1419a,b, and a damaged vial seal area 1445a,b (e.g., a bruised seal periphery, etc.). The three-dimensional model 1400a,b and/or the damaged vial seal area 1445a,b may be based on, for example, on X-axis data, Y-axis data, and Z-axis data.

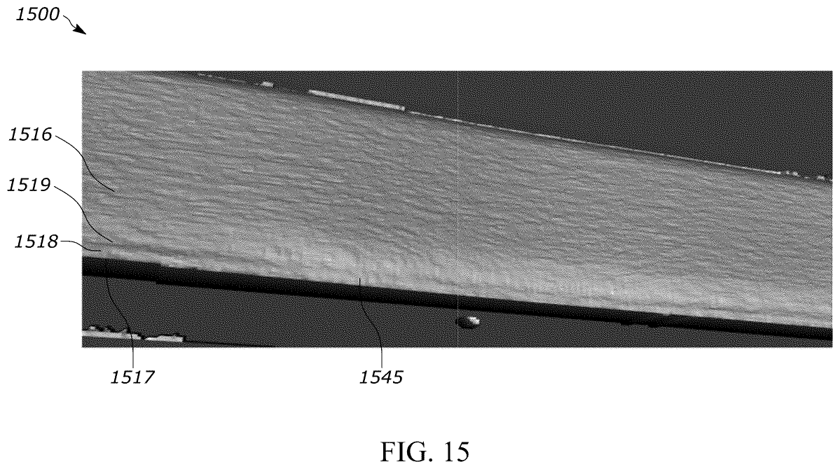

With reference to FIG. 15, a three-dimensional model 1500 of a vial seal may include a vial seal periphery surface 1516, a vial seal lower edge 1517, a vial seal crimp surface 1518, a vial seal crimp angle 1519, and a damaged vial seal area 1545 (e.g., a weak vial seal crimp, etc.). The three-dimensional model 1500 and/or the damaged vial seal area 1545 may be based on, for example, on X-axis data, Y-axis data, and Z-axis data. A vial seal crimp inspection based on 2D images may produce a higher number of erroneous results associated with a weak vial seal crimp compared to a vial seal crimp inspection based on vial seal 3D data. The vial seal 3D may be, for example, representative of a vial seal crimp angle 1519.

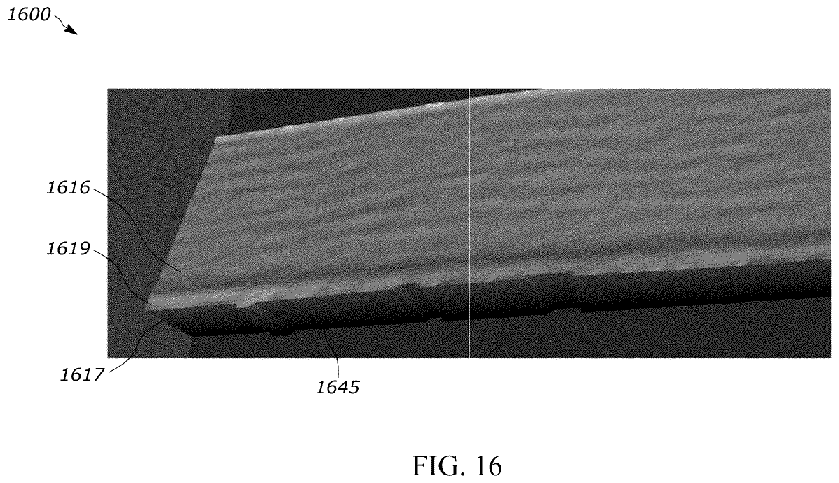

Turning to FIG. 16, a three-dimensional model 1600 of a vial seal may include a vial seal periphery surface 1616, a vial seal lower edge 1617, a vial seal crimp surface 1618, a vial seal crimp angle 1619, and a damaged vial seal area 1645 (e.g., a missing vial seal crimp, etc.). The three-dimensional vial seal model 1600 and/or the damaged vial seal area 1645 may be based on, for example, on X-axis data, Y-axis data, and Z-axis data. A vial seal crimp inspection based on 2D images may produce a higher number of erroneous results associated with a missing vial seal crimp compared to a vial seal crimp inspection based on vial seal 3D data. A missing vial seal crimp may be considered a critical fail that is detected with a higher degree of accuracy using the vial seal 3D data. For example, the straight edge 1617 may, for example, indicate no crimp, and that something happened during an associated vial seal crimping process and/or with associated blades.

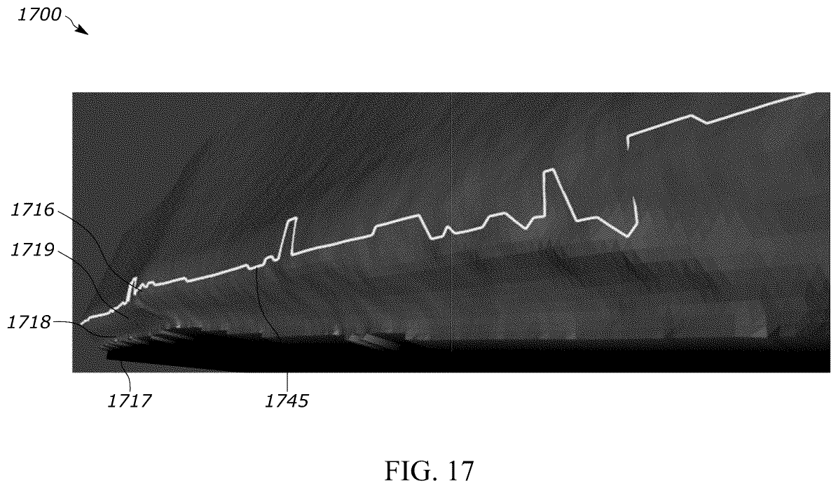

With reference to FIG. 17, a three-dimensional vial seal model 1700 of a vial seal may include a vial seal periphery surface 1716, a vial seal lower edge 1717, a vial seal crimp surface 1718, a vial seal crimp angle 1719, and a damaged vial seal area 1745 (e.g., an uneven vial crimp angle, etc.). The three-dimensional vial seal model 1700 and/or the damaged vial seal area 1745 may be based on, for example, on X-axis data, Y-axis data, and Z-axis data. A remote device 1150a may, for example, store vial seal 3D data that is representative of a full 360 degree profile of a vial seal crimp down to, for example, 0.1 mm resolution. After scanning at least one vial seal crimp surface, and getting a full 3D 360 degree representative of the vial seal crimp, the remote device, for example, may determine if the vial seal crimp is a fail or not, or may determine a probability of whether the vial seal crimp is acceptable. In any event, a vial seal inspection system 1100a may detect larger defects based on, for example, a comparison of Z-axis data with at least one of a near alarm 1091a,b and a far alarm 1092a,b.

For smaller vials with vial seal crimp defects, a vial seal inspection system 1100a may include over 300 scans or lines of a vial seal crimp surface and may, based thereon, generate over 300 consecutive vial seal crimp radius angles. Vial seal 3D data that is representative of a vial seal parameter 1719 is particularly useful for detecting defective vial seal crimp radii. Vial seal 3D data that is representative of a vial seal crimp radii may be used to tune the vial seal inspection system 1100a to detect, for example, loose vial seal crimps. Vial seal crimp inspection based on 2D image may not be effective to detect a loose vial seal crimp, i.e., an illumination change may have a false fail with 2D data, but in the case of a vial seal inspection system 1100a, illumination may effectively have zero effect on, for example, vial seal Z-axis distance measurements. A vial seal inspection system 1100a may receive actual Z-axis measurements, and may calculate a vial seal crimp radius based on corresponding Z-axis data.

A thin colored surface (e.g., 5 μm plastic covering, a blue coating, etc.) may be added to a vial seal outer surface 116, 118, 119. Vial seal 3D data may be based on, for example, vial seal inspection configuration data as illustrated in Table 1. Table 1 incudes ten possible scan speeds for a vial seal distance data generation device 1180b. The scan speed may be setup once, and then used in full vial inspection batches. For example, in configuration 2 Conf. #, a vial seal inspection system 1100a can give 326 scans or lines over the 360 degrees of the vial seal crimp, providing a resolution of 0.142 mm for the smaller vials (4 cc resolution) and 0.217 mm for the larger vials (50 cc resolution). Vial seal defects may be on an order of millimeters, therefore, a vial seal distance data generation device 1180a may be configured with resolution as illustrated in Table 1. Vial seal distance data generation device configuration 2, as shown in bold in Table 1, may work particularly well with vial seals 115 having a blue vial seal periphery surface.

TABLE 1
Ten different settings of the laser system which results in
resolutions of the scanned image from 0.11 mm to 0.512 mm

| | | Expo | Idle | 4 cc | 50 cc |
|---|---|---|---|---|---|
| Conf. # | Lines # | us | us | res | res |
| 0 | 420 | 220 | 30 | 0.110 | 0.168 |
| 1 | 366 | 260 | 30 | 0.126 | 0.193 |
| 2 | 326 | 300 | 30 | 0.142 | 0.217 |
| 3 | 294 | 340 | 30 | 0.157 | 0.240 |
| 4 | 268 | 380 | 30 | 0.172 | 0.264 |
| 5 | 246 | 420 | 30 | 0.188 | 0.287 |
| 6 | 228 | 460 | 30 | 0.203 | 0.310 |
| 7 | 212 | 500 | 30 | 0.218 | 0.333 |
| 8 | 180 | 600 | 30 | 0.257 | 0.393 |
| 9 | 156 | 700 | 30 | 0.296 | 0.453 |
| 10 | 138 | 800 | 30 | 0.335 | 0.512 |

As illustrated in Table 1, the vial seal distance data received from a corresponding vial seal distance data generation sensor 1080a, may be representative of scans or lines and may be used to generate a full 3D image of multiple scans. For example, in the case of a 4 cc vial from Table 1, the vial seal 3D data will have 328 lines.

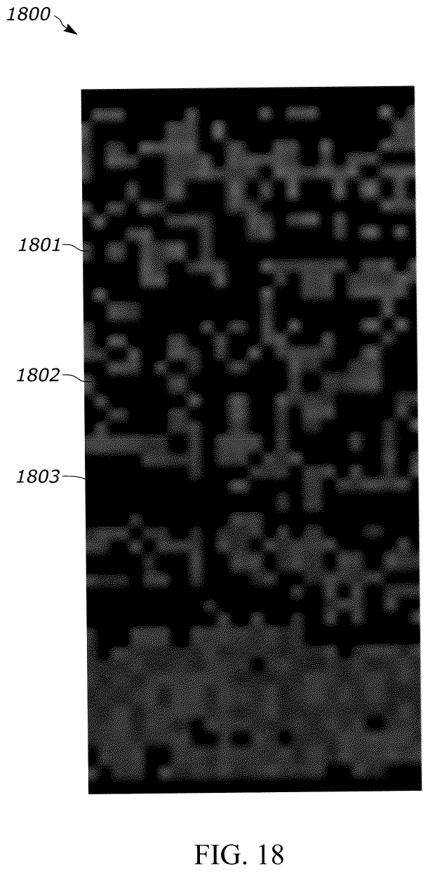

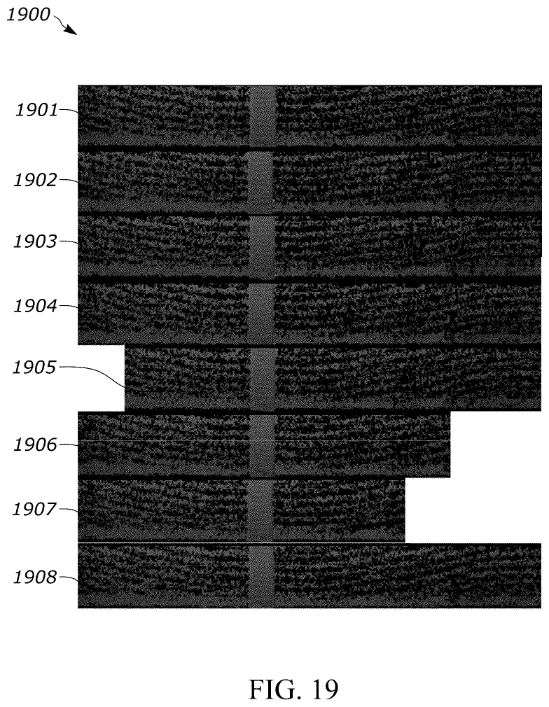

Turning to FIG. 18, dead spots 1801 are representative of areas on an associated vial seal 115 where an associated vial seal distance data generation sensor 1180a did not receive a reading. Variations between the areas 1802 and 1803 are representative of vial seal surface 116, 118, 119 variations.

With reference to FIG. 19, vial seal 3D data 1900 may be, for example, representative of eight different scans 1901-1908 of a vial seal, with times and a starting point aligned. The dead spots 1801 may cause excessive vial seal inspection errors.

As illustrated, the eight images 1901-1908 illustrate a pattern where the dead spots 1801 happen. Dead spots 1801 may very based on a vial seal covering color, surface texture, slight variation in the rotation movement of the vial, etc.

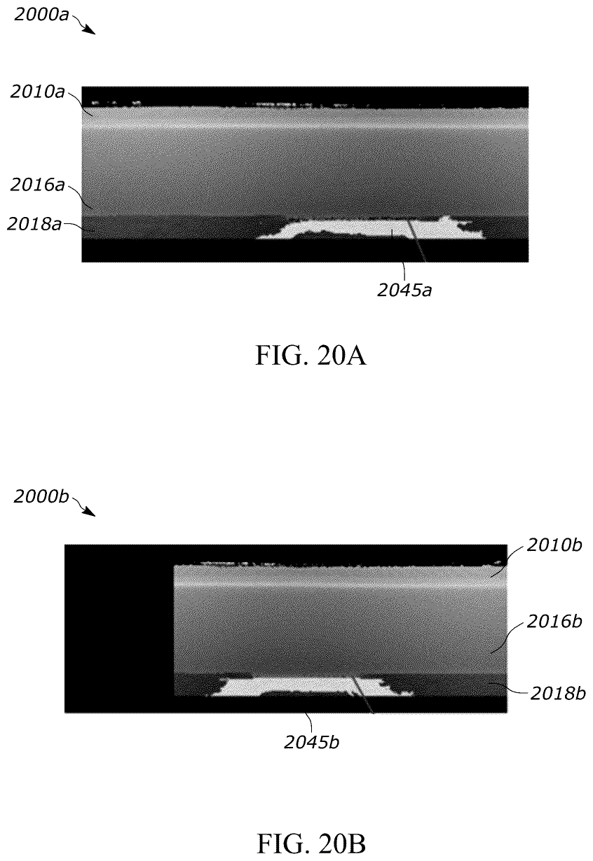

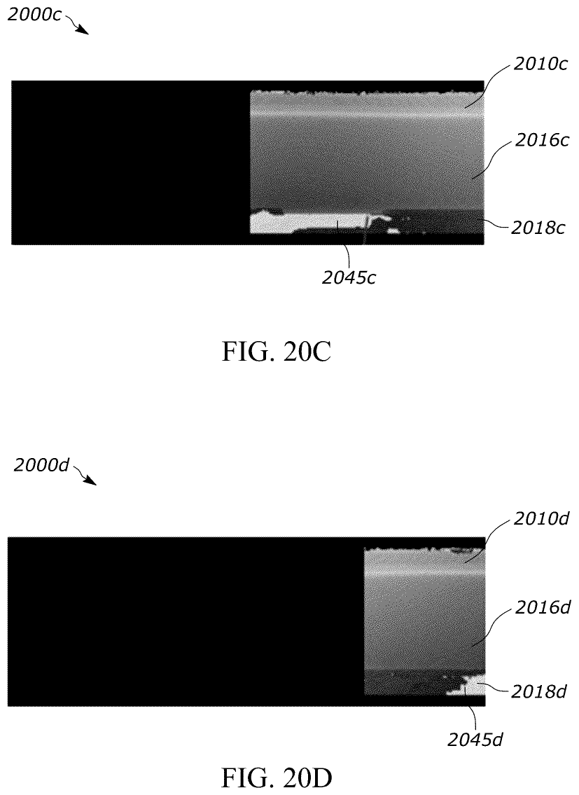

Turning to FIGS. 20A-D, vial seal three-dimensional models 2000a-d are representative of vial seal 3D data acquired from a vial seal distance data generation device 1180a with various exposure levels. As illustrated, increased exposure may reduce false fails. Dead spots 1801 may be generated by decreasing the exposure. A vial seal distance data generation device 1180a may be configured with a resolution that is based on a vial seal surface color and/or texture. For example, a thin film thickness on a surface of a vial seal may be approximately 5 micron (This is a typical value for a vial seal anodized aluminum coating). A vial seal distance data generation sensor may be, for example, configured with an incident angle of 20 degree, a refractive index of the film n may be approximately 1.5, and a wavelength of 658 nm, a minimal thickness needed to cause destructive interference (black spot in the images) may be determined. For example, a travel d of a laser beam 1082a,b within the coating may be equal to a quarter of the wavelength within the medium plus k times the wavelength itself (i.e. d=(λ/n)/4+k(λ/n)). At an incident angle of 20°, a (λ/n)/4 the change in thickness may cause destructive interference roughly equal to 105 nm+k(210 nm). As a specific example, four fringes could be caused by a monotone change in thickness of less the 1 micron.

The 3D system may be installed on a qualified visual inspection system in, for example, a computer network (e.g., system 1100a of FIG. 11A, etc.).

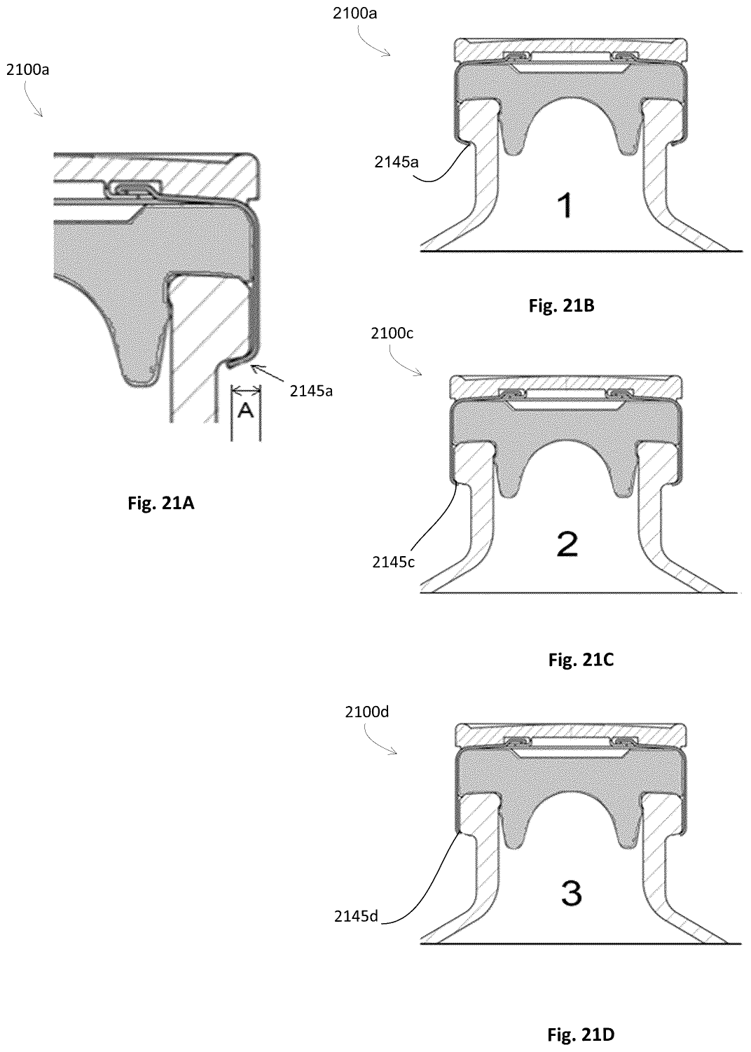

With reference to FIGS. 21A-D, a series of vial profile views 2100a, 2100c, and 2100d illustrate varying amounts of seal material in the form of crimps 2145a, 2145c, and 2145d (e.g., metal, etc.) tucked under a lip of a vial neck. The vials 2100a, 2100c, and 2100d illustrate a gradual reduction in crimp level. The Laser crimp inspection systems of FIGS. 9A-11G may, for example, provide a physical dimensional reading of the level of crimp 2145a, 2145c, and 2145d. The vial 2100a of FIG. 21B and FIG. 21A, which is a detail view of FIG. 21B, includes crimp 2145a having an amount of material (e.g., metal, etc.) that is tucked under a vial neck on a typical well sealed vial. The laser system 900a-11G may, for example, detect/measure a dimension (marked “A” in FIG. 21A) of the crimp 2145a, 2145c, 2145d to determine the level of crimp and identify whether sub-optimal sealing and sealing defects exist. For example, in FIGS. 21C and 21D, the vials 2100c and 2100 include a level of crimp 2145c and 2145d that is reduced relative to crimp 2145a and, as such, the Laser crimp inspection system of FIGS. 9A-11G, for example, may identify these as possessing sub-optimal sealing and/or sealing defects. That is, in FIGS. 21C and 21D, the crimps 2145c and 2145d include an amount of tuck (i.e., a dimension A of the associated crimp) that can be seen to gradually decrease to the point that any seal intended to be present by the crimp may be compromised.

Although the devices, systems, assemblies, components, subsystems and methods have been described in terms of exemplary embodiments, they are not limited thereto. The detailed description is to be construed as exemplary only and does not describe every possible embodiment of the present disclosure. Numerous alternative embodiments could be implemented, using either current technology or technology developed after the filing date of this patent that would still fall within the scope of the claims defining the invention(s) disclosed herein.

Those skilled in the art will recognize that a wide variety of modifications, alterations, and combinations can be made with respect to the above described embodiments without departing from the spirit and scope of the invention(s) disclosed herein, and that such modifications, alterations, and combinations are to be viewed as being within the ambit of the inventive concept(s).

1. A vial seal inspection system, the system comprising:
a vial seal distance data generation device configured to generate vial seal distance data, wherein the vial seal distance data is representative of a plurality of distance measurements correlated with points along at least a portion of a line that extends from a top of the vial seal to a bottom edge of the vial seal;
a vial seal periphery data generation device configured to generate vial seal periphery data, wherein the vial seal periphery data is representative of a plurality of points along at least a portion of a line that extends around a periphery of the vial seal;
a vial seal three-dimensional data generation module stored on a memory that, when executed by a processor, causes the processor to generate vial seal three-dimensional data based on the vial seal distance data and the vial seal periphery data; and
a vial seal inspection data generation module stored on a memory that, when executed by a processor, causes the processor to generate vial seal inspection data based on a comparison of the vial seal three-dimensional data with previously classified vial seal three-dimensional data, wherein the vial seal inspection data is indicative of whether the vial seal includes a vial seal crimp.

2. The system of claim 1, wherein the vial seal distance data generation device includes at least one laser triangulation sensor.

3. The system of claim 1, further comprising:
a vial seal distance data generation sensor angle manual adjustment mechanism, wherein a vial seal distance data generation sensor angle is manually adjusted to include more of, or less of, either a vial seal periphery surface or a vial seal crimp surface within a measurement range.

4. The system of claim 1, wherein a vial seal distance data generation sensor perpendicular angle is representative of an angle between a vial central axis and a line that extends from a vial seal distance data generation sensor near alarm distance point to a vial seal distance data generation sensor far alarm distance point.

5. The system of claim 1, wherein a vial seal distance data generation sensor angle is configured to scan a curved surface of a vial seal crimp which extends under a vial lip.

6. The system of claim 1, further comprising:
A vial seal distance data generation device configuration data receiving module stored on a memory, that when executed by a processor, causes the processor to receive vial seal distance data generation device configuration data, wherein the vial seal distance data generation device configuration data is representative of at least one of: a sensor stand-off height, a sensor exposure and a scan rate.

7. The system of claim 1, wherein the vial seal inspection data is representative of Z-axis data associated with at least one surface of a vial seal.

8. A vial seal inspection device, the device comprising:
a vial seal distance data generation sensor configured to generate vial seal distance data, wherein the vial seal distance data is representative of a plurality of distance measurements correlated with points along at least a portion of a line that extends from a top of the vial seal to a bottom edge of the vial seal;
a vial seal periphery data input, wherein the vial seal periphery data input is representative of a plurality of points along at least a portion of a line that extends around a periphery of the vial seal; and
a vial seal three-dimensional model generation module stored on a memory that, when executed by a processor, causes the processor to generate vial seal three-dimensional data based on the vial seal distance data and the vial seal periphery data.

9. The device of claim 8, wherein the vial seal distance data generation sensor includes at least one laser triangulation sensor.

10. The device of claim 8, wherein the vial seal three-dimensional data is representative of at least one surface of a vial seal.

11. The device of claim 8, wherein the vial seal three-dimensional data is representative of at least one surface of a vial seal crimp.

12. The device of claim 8, wherein the vial seal three-dimensional data is representative a radii of curvature of a vial seal crimp.

13. The device of claim 8, further comprising:
a vial seal distance data generation device configuration data receiving module stored on a memory, that when executed by a processor, causes the processor to receive vial seal distance data generation device configuration data, wherein the vial seal distance data generation device configuration data is representative of at least one of: a sensor stand-off height, a sensor exposure and a scan rate.

14. The device of claim 8, further comprising:
a vial seal perimeter distance data receiving module stored on a memory, that when executed by a processor, causes the processor to receive vial seal perimeter distance data.

15. The device of claim 14, wherein the vial seal perimeter distance data is predetermined.

16. A non-transitory computer-readable medium storing computer-readable instructions that, when executed by one or more processors, cause the one or more processors to generate vial seal three-dimensional data, the computer-readable medium comprising:
a vial seal distance data receiving module that, when executed by a processor, causes the processor to receive vial seal distance data from a vial seal distance data generation device, wherein the vial seal distance data is representative of a plurality of distance measurements correlated with points along at least a portion of a line that extends from a top of the vial seal to a bottom edge of the vial seal;
a vial seal periphery data receiving module that, when executed by a processor, causes the processor to receive vial seal periphery data, wherein the vial seal periphery data is representative of a plurality of points along at least a portion of a line that extends around a periphery of the vial seal; and
a vial seal three-dimensional data generation module that, when executed by a processor, causes the processor to generate vial seal three-dimensional data based on the vial seal distance data and the vial seal periphery data.

17. The computer-readable medium of claim 16, further comprising:
A vial seal distance data generation device configuration data receiving module, that when executed by a processor, causes the processor to receive vial seal distance data generation device configuration data, wherein the vial seal distance data generation device configuration data is representative of at least one of: a sensor stand-off height, a sensor exposure and a scan rate.

18. The computer-readable medium of claim 16, further comprising:
a vial seal perimeter distance data receiving module stored on a memory, that when executed by a processor, causes the processor to receive vial seal perimeter distance data.

19. The computer-readable medium of claim 18, wherein the vial seal perimeter distance data is based on a vial rotation rate.

20. The computer-readable medium of claim 16, wherein a vial seal distance data generation sensor perpendicular angle is representative of an angle between a vial central axis and a line that extends from a vial seal distance data generation sensor near alarm distance point to a vial seal distance data generation sensor far alarm distance point.
